(19) United States
(12) Patent Application Publication
(10) Pub. No.: US 2015/0372487 A1
(43) Pub. Date: Dec. 24, 2015

(54) POWER ROUTER AND OPERATION CONTROL METHOD THEREOF, POWER NETWORK SYSTEM, AND NON-TRANSITORY COMPUTER READABLE MEDIA STORING PROGRAM

(71) Applicants: Rikiya ABE, Kanagawa (JP); NEC Corporation, Tokyo (JP)

(72) Inventors: Rikiya ABE, Kanagawa (JP); Noriaki KOBAYASHI, Tokyo (JP); Sadaharu TAMOTO, Shizuoka (JP); Shinichiro SHISHIKURA, Tokyo (JP)

(21) Appl. No.: 14/763,654

(22) PCT Filed: Jan. 28, 2014
(86) PCT No.: PCT/JP2014/000419

§ 371 Date: Jul. 27, 2015

(30) Foreign Application Priority Data
Jan. 28, 2013 (JP) 2013-013633

(51) Int. Cl. H02J 3/12; H02M 7/68; G05B 15/02; H02M 7/04

(52) U.S. Cl. CPC H02J 3/12; H02M 7/04; H02M 7/68; G05B 15/02

(57) ABSTRACT

A management or control of a power router is more appropriately performed when a power network system in which power cells are asynchronously connected with each other. A plurality of power conversion legs bi-directionally convert power, one ends thereof are connected with a direct current bus and the other ends thereof are connected with an external connection destination as an external connection terminal. A control unit controls operations of the plurality of power conversion legs. The control unit receives a control instruction including a designation of an activation target leg and a designation of an operation mode of the activation target leg. The control unit determines whether the activation target leg can be activated in a designated operation mode. The control unit activates the activation target leg in the designated operation mode when the activation target leg can be activated in the designated operation mode.

### TECHNICAL FIELD

The present invention relates to a power router and an operation control method thereof, a power network system, a non-transitory computer readable media storing program.

### BACKGROUND ART

When a power supply system is constructed, important challenges are not only to safely expand a power transmission network but also to construct the system so that a large quantity of natural energy can be introduced into the system in the future. Therefore, as a new power network, a power network system called “digital grid” (registered trademark) has been proposed (Patent Literatures 1 and 2).

The digital grid (registered trademark) is a power network system in which a power network is sub-divided into small cells and these cells are connected with each other in an asynchronous manner. The size of each power cell ranges from a smaller one such as a cell corresponding to one house, one building, or one commercial facility to a larger one such as a cell corresponding to one prefecture or one municipality. Each power cell includes loads and, in some cases, a generator facility and/or a power storage facility. Examples of the generator facility include generator facilities using natural energy such as a solar generator, an aerogenerator, and a geothermal power plant.

Power cells are connected with each other in an asynchronous manner so that electricity can be generated inside a cell without restraint and power is flexibly interchanged between power cells. That is, although a plurality of power cells are connected to each other, the voltage, the phase, and the frequency of the power used in each power cell are asynchronous to each other.

FIG. 16 shows an example of a power network system 810. In FIG. 16, a core system 811 transmits backbone power from a large-scale power plant 812. Further, each of a plurality of power cells 821 to 824 are disposed. The power cells 821 to 824 includes loads such as houses 831 and buildings 832, generator facilities (e.g., a solar panel 833 and an aerogenerator 834), and power storage facilities (e.g., a storage battery 835).

In the specification of the present application, generator facilities and power storage facilities are also collectively referred to as “distributed power supplies”.

Further, the power cells 821 to 824 include their respective power routers 841 to 844 each of which serves as a connection inlet/outlet (connection port) for connection to other power cells and/or the core system 811. Each of the power routers 841 to 844 includes a plurality of legs (LEGs). (Because of the width of the paper, the symbols of the legs are omitted in FIG. 16. White circles in the power routers 841 to 844 represent the connection terminals of their legs.)

Note that each leg includes a connection terminal(s) and a power conversion unit(s), and has an address assigned thereto. Note that the power conversion by a leg means a conversion from an AC (Alternating Current) into a DC (Direct Current), a conversion from a DC to an AC, or a change in the voltage, the frequency, or the phase.

All the power routers 841 to 844 are connected to a management server 850 through a communication network 851, and managed and controlled by the management server 850 in a unified manner. For example, the management server 850 provides an instruction for power transmission or power reception performed by each leg to the power routers 841 to 844 by using the address assigned to each leg. In this way, a power interchange between power cells is performed through the power routers 841 to 844.

By enabling a power interchange to be performed between power cells, it is possible, for example, to enable a plurality of power cells to use one common generator facility (e.g., the solar panel 833 and the aerogenerator 834) and/or one common power storage facility (the storage battery 835). If surplus power is reciprocally interchanged between power cells, it is possible to stably maintain the power supply/demand balance while considerably reducing the facility costs.

### CITATION LIST

### Patent Literature

Patent Literature 1: Japanese Patent No. 4783453
Patent Literature 2: Japanese Unexamined Patent Application Publication No. 2011-83085

### SUMMARY OF INVENTION

### Technical Problem

If a plurality of power cells can be connected by their power routers in an asynchronous manner, this is significantly advantageous. Therefore, it has been desired to commercially implement power routers as soon as possible.

However, there is a particular problem, which the conventional power transmission/distribution facility does not have, for actually putting the power router to practical use. The currently mainstream power transmission/distribution supposes a power system in which voltage, phase, and frequency are completely synchronized, so that the power router connecting the power systems that have different voltage, phase, or frequency needs an attention for new problems.

The present invention has been made to solve the above-described problem and an object thereof is to manage a power router more appropriately when a power network system in which power cells are asynchronously connected with each other is constructed.

### Solution to Problem

An aspect of the present invention is a power router including: a direct current bus in which a voltage thereof is maintained at a predetermined rating; a plurality of power conversion legs that bi-directionally converts power between a first connection terminal and a second connection terminal, the first connection terminal of the power conversion leg being connected with the direct current bus, the second connection terminal of the power conversion leg being connected with an external connection destination as an external connection terminal; and a control means for controlling operations of the plurality of power conversion legs. The control means: receives a control instruction including a designation of an activation target leg that is a target leg to be activated in the plurality of power conversion legs and a designation of an operation mode of the activation target leg; determines whether the activation target leg can be activated in a designated operation mode; and activates the activation target leg in the designated operation mode when the activation target leg can be activated in the designated operation mode.

An aspect of the present invention is a power network system including: one or more power routers; and a power system that is directly or indirectly connected with the power router. Each of the one or more power routers includes: a direct current bus in which a voltage thereof is maintained at a predetermined rating; a plurality of power conversion legs that bi-directionally converts power between a first connection terminal and a second connection terminal, the first connection terminal of the power conversion leg being connected with the direct current bus, the second connection terminal of the power conversion leg being connected with an external connection destination as an external connection terminal; and a control means for controlling operations of the plurality of power conversion legs. The control means: receives a control instruction including a designation of an activation target leg that is a target leg to be activated in the plurality of power conversion legs and a designation of an operation mode of the activation target leg; determines whether the activation target leg can be activated in a designated operation mode; and activates the activation target leg in the designated operation mode when the activation target leg can be activated in the designated operation mode.

An aspect of the present invention is an operation control method of a power router, the power router including: a direct current bus in which a voltage thereof is maintained at a predetermined rating; a plurality of power conversion legs that bi-directionally converts power between a first connection terminal and a second connection terminal, the first connection terminal of the power conversion leg being connected with the direct current bus, the second connection terminal of the power conversion leg being connected with an external connection destination as an external connection terminal; and a control means for controlling operations of the plurality of power conversion legs. The method including: receiving a control instruction including a designation of an activation target leg that is a target leg to be activated in the plurality of power conversion legs and a designation of an operation mode of the activation target leg; determining whether the activation target leg can be activated in a designated operation mode; and activating the activation target leg in the designated operation mode when the activation target leg can be activated in the designated operation mode.

An aspect of the present invention is a power router operation control program, the power router including: a direct current bus in which a voltage thereof is maintained at a predetermined rating; a plurality of power conversion legs that bi-directionally converts power between a first connection terminal and a second connection terminal, the first connection terminal of the power conversion leg being connected with the direct current bus, the second connection terminal of the power conversion leg being connected with an external connection destination as an external connection terminal; and a computer that configures a control means for controlling operations of the plurality of power conversion legs. The program causing the computer to execute: a process of receiving a control instruction including a designation of an activation target leg that is a target leg to be activated in the plurality of power conversion legs and a designation of an operation mode of the activation target leg; a process of determining whether the activation target leg can be activated in a designated operation mode; and a process of activating the activation target leg in the designated operation mode when the activation target leg can be activated in the designated operation mode.

An aspect of the present invention is a management device control program including: one or more power routers; a power system that is directly or indirectly connected with the power router; and a computer that configures a management device controlling operations of the one or more power routers. Each of the one or more power routers includes: a direct current bus in which a voltage thereof is maintained at a predetermined rating; a plurality of power conversion legs that bi-directionally converts power between a first connection terminal and a second connection terminal, the first connection terminal of the power conversion leg being connected with the direct current bus, the second connection terminal of the power conversion leg being connected with an external connection destination as an external connection terminal; and a control means for controlling operations of the plurality of power conversion legs. The program causes the computer to execute a process of outputting a control instruction including a designation of an activation target leg that is a target leg to be activated in the plurality of power conversion legs and a designation of an operation mode of the activation target leg to the activation target leg included in any one of the one or more power routers. The control means: determines whether the activation target leg can be activated in a designated operation mode; and activates the activation target leg in the designated operation mode when the activation target leg can be activated in the designated operation mode.

### Advantageous Effects of Invention

According to the present invention, it is possible to manage or control a power router more appropriately when a power network system in which power cells are asynchronously connected with each other.

### BRIEF DESCRIPTION OF DRAWINGS

FIG. 1 is a block diagram illustrating a schematic configuration of a power router 100;

FIG. 2 is a block diagram of the power router 100 illustrating an example of internal structures of legs;

FIG. 3 is a block diagram of the power router 100 more specifically illustrating the internal structure of the leg;

FIG. 4 is a block diagram illustrating a configuration example of a power router 170 including an AC through leg 60;

FIG. 5 is a block diagram schematically showing a relation between a configuration of a control unit 19 and an activation target leg;

FIG. 6 is a flow chart showing an activation procedure of the activation target leg in the power router 100;

FIG. 7 is a flow chart showing a procedure of an operation mode adequacy determination S2;

FIG. 8 is a flow chart showing a procedure of a leg activation step S3;

FIG. 9 is a flow chart showing a procedure of initiating a power transmission of a power router 200;

FIG. 10 is a flow chart showing a procedure of a first power transmission adjustment processing step S61 of the power router 200;

FIG. 11 is a flow chart showing a procedure of a second power transmission adjustment processing step S71 of the power router 200;

FIG. 12 is a flow chart showing a procedure of a third power transmission adjustment processing step S73 of the power router 200;

FIG. 13 is a block diagram schematically showing a configuration of a power network system 1001 that is an example of a power network system;

FIG. 14 is a block diagram schematically showing a configuration of a power network system 1002 that is an example of the power network system;

FIG. 15 is a block diagram schematically showing a configuration of a power network system 1003 that is an example of the power network system; and

FIG. 16 shows an example of a power network system 810.

### DESCRIPTION OF EMBODIMENTS

Exemplary embodiments of the present invention will be described below with reference to the drawings. A specific configuration of the above-described power router will be described in the following exemplary embodiments. In this regard, each exemplary embodiment by no means limits the present invention only to a power router, and it can be understood that the present invention includes other components such as a device in which the power router is embedded. The same elements will be assigned the same reference numerals in each drawing, and will not be described when necessary.

### First Exemplary Embodiment

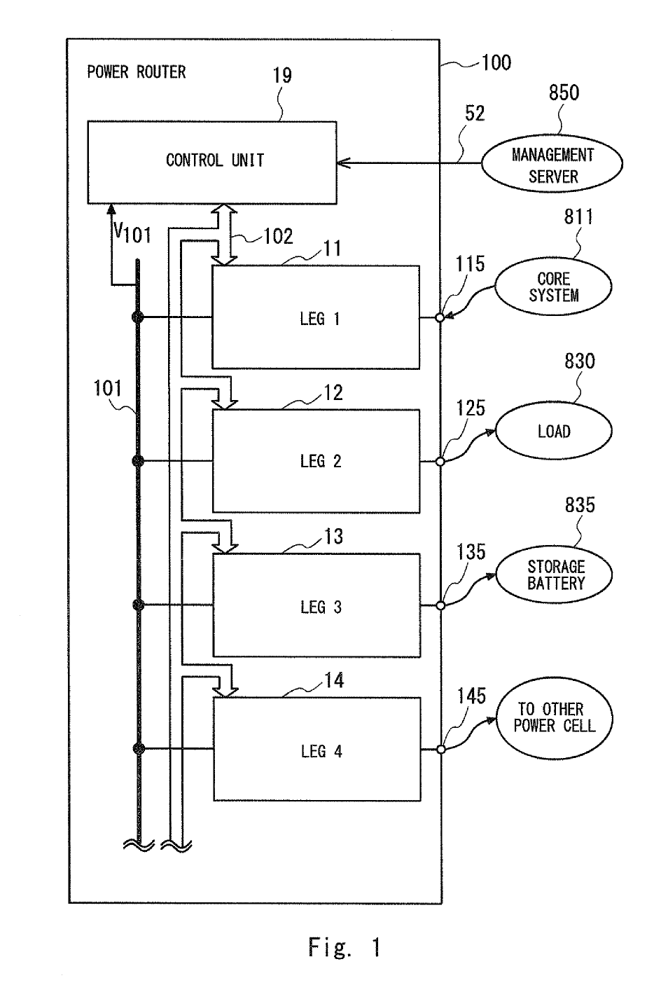

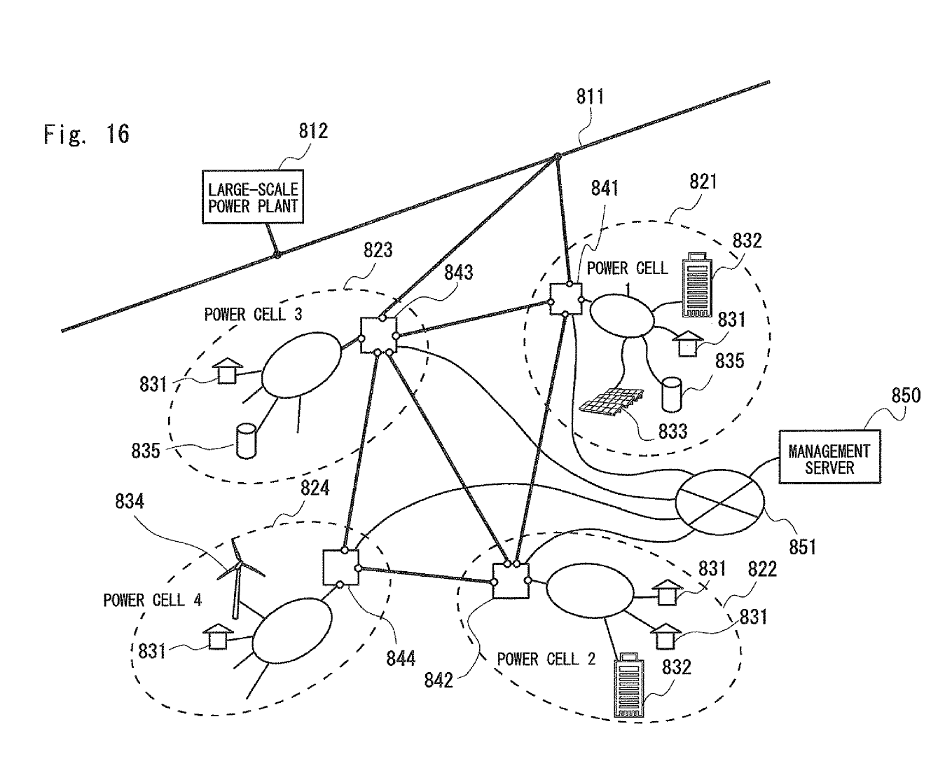

Activation of a power router and activation of a leg included in the power router will be specifically described in the present exemplary embodiment. Here, a power router 100 according to a first exemplary embodiment will be firstly described. The power router 100 is a specific example of above power routers 841 to 844 (FIG. 16). FIG. 1 is a block diagram illustrating a schematic configuration of the power router 100. The power router 100 roughly includes a direct current (DC) bus 101, a first leg 11, a second leg 12, a third leg 13, a fourth leg 14 and a control unit 19. In addition, in the drawing, the first leg to the fourth leg are indicated as a leg 1 to a leg 4, respectively, for convenience of the drawings.

The DC bus 101 is connected with the first leg 11 to the fourth leg 14 in parallel. The DC bus 101 feeds DC power. The control unit 19 maintains a bus voltage V₁₀₁ of the DC bus 101 at a predetermined fixed value by controlling operation states of the first leg 11 to the fourth leg 14 (an operation of feeding power to an outside, an operation of receiving power from the outside and the like) through a communication bus 102. That is, the power router 100 is connected to the outside through the first leg 11 to the fourth leg 14, converts all power which is interchanged with the outside, into DC power once and flows the DC power on the DC bus 101. By converting power into DC power once, it is possible to asynchronously connect power cells even when frequencies, voltages or phases are different.

In addition, an example where the power router 100 includes four legs will be described in the present exemplary embodiment. However, the present exemplary embodiment is only exemplary. The power router can be provided with an arbitrary number of legs equal to or more than two legs. In the present exemplary embodiment, the first leg 11 to the fourth leg 14 employ the same configuration. However, the two or more legs included in the power router may employ the same configuration or different configurations. In addition, a leg will be also referred to as a power converting leg below.

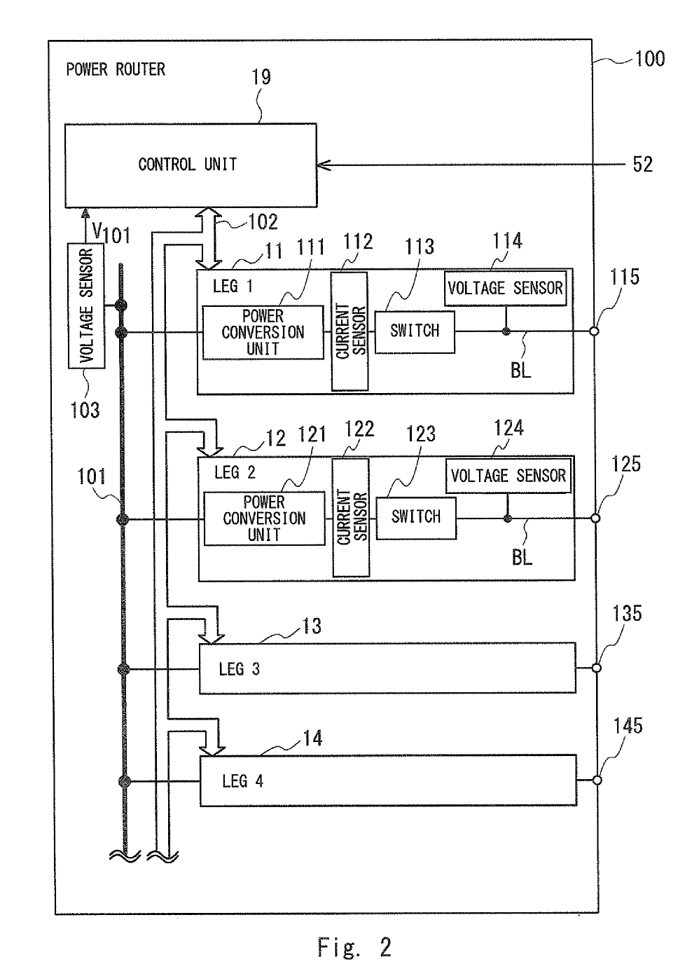

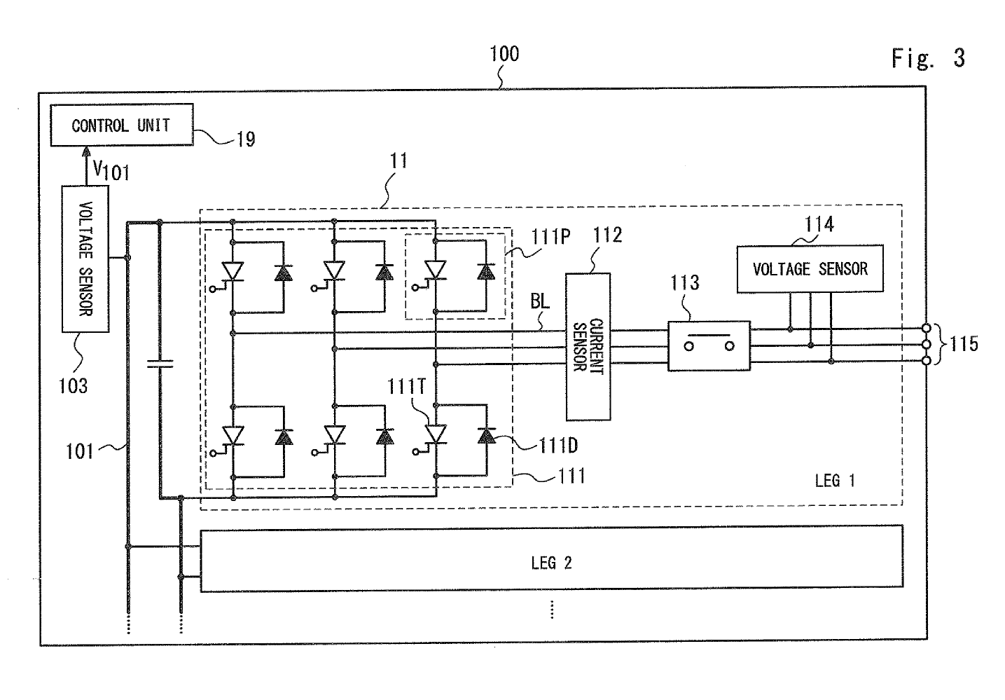

Next, the first leg 11 to the fourth leg 14 will be described. FIG. 2 is a block diagram of the power router 100 illustrating an example of internal structures of the legs. The first leg 11 to the fourth leg 14 employ the same configuration. However, for simplification of the drawings, FIG. 2 illustrates the internal structures of the first leg 11 and the second leg 12, and does not illustrate the internal structures of the third leg 13 and the fourth leg 14. FIG. 3 is a block diagram of the power router 100 more specifically illustrating the internal structure of the leg. The first leg 11 to the fourth leg 14 employ the same configuration. However, for simplification of the drawings, FIG. 3 illustrates the internal structure of the first leg 11, and does not illustrate the internal structure of the second leg 12, the third leg 13, the fourth leg 14 and the communication bus 102.

The first leg 11 to the fourth leg 14 are provided to the DC bus 101 in parallel. As described above, the first leg 11 to the fourth leg 14 employ the same configuration. Hereinafter, a configuration of the first leg 11 will be typically described.

As illustrated in FIG. 2, the first leg 11 includes a power converting unit 111, a current sensor 112, a switch 113 and a voltage sensor 114. The first leg 11 is connected to, for example, a core system 811 through a connection terminal 115. The power converting unit 111 converts alternating current (AC) power into DC power or DC power into AC power. DC power flows in the DC bus 101, i.e., the power converting unit 111 converts the DC power of the DC bus 101 into AC power of a fixed frequency and voltage and flows the AC power to an outside from the connection terminal 115. Alternatively, the power converting unit 111 converts the AC power flowing from the connection terminal 115 into DC power, and flows the DC power to the DC bus 101.

The power converting unit 111 employs a configuration of an inverter circuit. More specifically, as illustrated in FIG. 3, the power converting unit 111 employs a configuration in which antiparallel circuits 111P each including a thyristor 111T and a feedback diode 111D are connected by way of a three-phase bridge. That is, one inverter circuit (power converting unit 111) includes the six antiparallel circuits 111P. A wire which is led from a node between the two antiparallel circuits 111P and connects this node with the connection terminal will be referred to as a branch line BL. A three-phase alternating current is used, and therefore one leg includes the three branch lines BL in this case. In this regard, a three-phase inverter circuit is used since the three-phase alternating current is used. However, a single-phase inverter circuit may be used depending on cases.

The switch 113 is disposed between the power converting unit 111 and the connection terminal 115. By opening and closing this switch 113, the branch line BL is opened and closed. Thus, the DC bus 101 is isolated from or connected with the outside. The current sensor 112 and the voltage sensor 114 output detection values to the control unit 19 through the communication bus 102.

A case where the power converting unit is the inverter circuit and leg connection parties use alternating currents has been described above. However, there is also a case where a leg connection party uses a direct current similar to a battery 835 (e.g. the third leg 13 in FIG. 1 is connected to the battery 835). Power conversion in this case is DC-DC conversion.

Hence, by providing an inverter circuit and a converter circuit in parallel in a power converting unit, an inverter circuit and a converter circuit may be separately used according to whether a connection party uses an alternating current or a direct current.

Alternatively, a DC-DC conversion dedicated leg where a power converting unit is a DC-DC converting unit may be provided. In addition, providing a power router which has AC-DC conversion dedicated legs and DC-DC conversion dedicated legs in combination also provides more advantages in terms of a size and cost than providing an inverter circuit and a converter circuit in parallel in each of all legs.

The second leg 12 includes a power converting unit 121, a current sensor 122, a switch 123 and a voltage sensor 124. The leg 12 is connected to, for example, a load 830 through a connection terminal 125. The power converting unit 121, the current sensor 122, the switch 123 and the voltage sensor 124 of the second leg 12 correspond to the power converting unit 111, the current sensor 112, the switch 113 and the voltage sensor 114 of the first leg 11, respectively. The connection terminal 125 connected with the second leg 12 corresponds to the connection terminal 115 connected with the first leg 11. The power converting unit 121 employs a configuration in which antiparallel circuits 121P each including a thyristor 121T and a feedback diode 121D are connected by way of a three-phase bridge. The thyristor 121T, the feedback diode 121D and the antiparallel circuit 121P correspond to the thyristor 111T, the feedback diode 111D and the antiparallel circuit 111P, respectively.

The third leg 13 includes a power converting unit 131, a current sensor 132, a switch 133 and a voltage sensor 134. The third leg 13 is connected to, for example, the battery 835 through a connection terminal 135. The power converting unit 131, the current sensor 132, the switch 133 and the voltage sensor 134 of the third leg 13 correspond to the power converting unit 111, the current sensor 112, the switch 113 and the voltage sensor 114 of the first leg 11, respectively. The connection terminal 135 connected with the third leg 13 corresponds to the connection terminal 115 connected with the first leg 11. The power converting unit 131 employs a configuration in which antiparallel circuits 131P each including a thyristor T and a feedback diode 131D are connected by way of a three-phase bridge. The thyristor 131T, the feedback diode 131D and the antiparallel 131P correspond to the thyristor 111T, the feedback diode 111D and the antiparallel circuit 111P, respectively. In this regard, for simplification of the drawings, the internal structure of the third leg 13 is not illustrated in FIGS. 2 and 3.

The fourth leg 14 includes a power converting unit 141, a current sensor 142, a switch 143 and a voltage sensor 144. The fourth leg 14 is connected to, for example, another power cell through a connection terminal 145. The power converting unit 141, the current sensor 142, the switch 143 and the voltage sensor 144 of the fourth leg 14 correspond to the power converting unit 111, the current sensor 112, the switch 113 and the voltage sensor 114 of the first leg 11, respectively. The connection terminal 145 connected with the fourth leg 14 corresponds to the connection terminal 115 connected with the first leg 11. The power converting unit 141 employs a configuration in which antiparallel circuits 141P each including a thyristor 141T and a feedback diode 141D are connected by way of a three-phase bridge. The thyristor 141T, the feedback diode 141D and the antiparallel circuit 141P correspond to the thyristor 111T, the feedback diode 111D and the antiparallel circuit 111P, respectively. In this regard, for simplification of the drawings, the internal structure of the fourth leg 14 is not illustrated in FIGS. 2 and 3.

The control unit 19 receives a control instruction 52 from the external management server 850 through the communication network 851. The control instruction 52 includes information for instructing an operation of each leg of the power router 100. In addition, the operation instruction of each leg includes, for example, a designation of power transmission/power reception, a designation of an operation mode and a designation of power to be transmitted or received.

More specifically, the control unit 19 monitors the bus voltage V₁₀₁ of the DC bus 101 through a voltage sensor 103, and controls a power direction, a frequency of AC power and the like. That is, the control unit 19 controls switching of the thyristors 111T, 121T and 131T and opening/closing of the switches 113, 123, 133 and 143 through the communication bus 102.

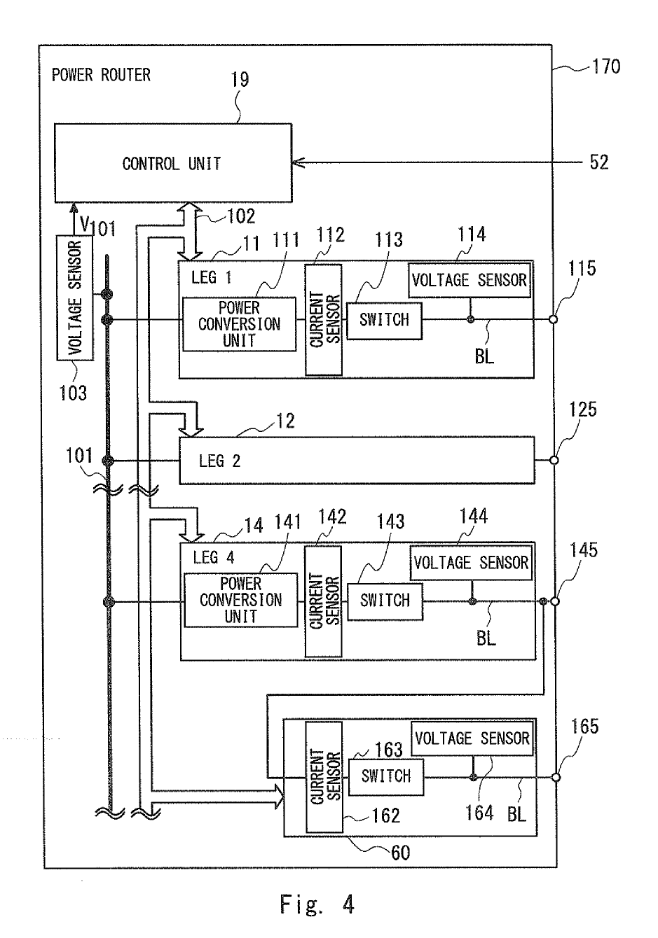

In addition, the leg having the power converting unit has been described above. However, it is also possible to provide a leg without a power converting unit. Hereinafter, the leg without the power converting unit will be temporarily referred to as an AC (Alternating Current) through leg 60. FIG. 4 is a block diagram illustrating a configuration example of a power router 170 including the AC through leg 60. The power router 170 employing a configuration provided by adding the AC through leg 60 to the power router 100 will be described. In addition, for simplification of the drawings, the third leg 13 is not illustrated in FIG. 4. Further, the leg is configured by using the thyristor that is a separately-excited power conversion device. However, it is only exemplary. For example, the leg may be configured by using an IGBT (Insulated Gate Bipolar Transistor) or a MOSFET (Metal-Oxide-Semiconductor Field-Effect Transistor) that is a self-excited power conversion device instead of the thyristor.

The AC through leg 60 includes a current sensor 162, a switch 163 and a voltage sensor 164. The AC through leg 60 is connected to, for example, another power cell through a connection terminal 165. A branch line BL of the AC through leg 60 is connected to the branch line BL of another leg having the power converting unit through the switch 163. That is, the connection terminal 165 connected with the AC through leg 60 is connected to a connection terminal connected with another leg including the power converting unit. FIG. 4 illustrates that, for example, the connection terminal 165 connected with the AC through leg 60 is connected to the connection terminal 145 connected with the fourth leg 14. Only the switch 163 is provided between the connection terminal 165 of the AC through leg 60 and the connection terminal 145 connected with the fourth leg 14, and the AC through leg 60 does not include a power converter. Hence, power is conducted without being converted at all between the connection terminal 165 connected with the AC through leg 60 and the connection terminal 145 connected with the fourth leg 14. Therefore, the leg without a power converter is referred to as an AC through leg.

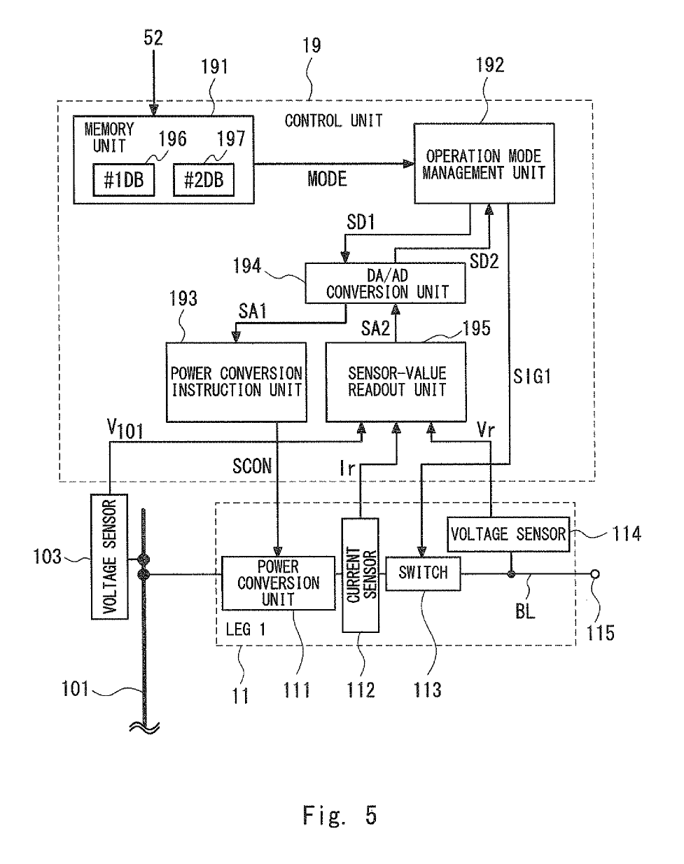

FIG. 5 is a block diagram schematically showing a relation between a configuration of the control unit 19 and an activation target leg. In FIG. 5, the case where the first leg 11 is designated as the activation target leg is represented. In the present exemplary embodiment, the case where the first leg 11 is designated as the activation target leg will be described below. The control unit 19 includes a memory unit 191, an operation mode management unit 192, a power conversion instruction unit 193, a DA/AD conversion unit 194, and a sensor-value readout unit 195.

The memory unit 191 holds the control instruction 52 from the management server 850 as a control instruction database 196 (a first database, which is represented by #1DB in the drawings). The memory unit 191 holds a leg identification information database 197 (a second database, which is represented by #2DB in the drawings) for identifying each of the first leg 11 to the fourth leg 14 as well as the control instruction database 196. The memory unit 191 can be achieved by various types of the memory unit such as a flash memory, etc. The leg identification information database 197 is information, e.g., an IP address, URL, URI and so on, allocated for specifying each of the first leg 11 to the fourth leg 14.

The operation mode management unit 192 is configured by a CPU, for example. The operation mode management unit 192 reads out an operation mode designation information MODE, which is included in the control instruction database 196 and designates an operation mode (the operation mode will be described below) of the activation target leg (the first leg 11). The operation mode management unit 192 also refers to the leg identification information database 197 in the memory unit 191 and reads out information (e.g., the IP address) corresponding to the activation target leg (the first leg 11). Thus, the operation mode management unit 192 can output an activation instruction with respect to the activation target leg (the first leg 11). The operation mode management unit 192 outputs a waveform instruction signal SD1 that is a digital signal. Further, the operation mode management unit outputs a switching control signal SIG1 to the switch 113 in the activation target leg (the first leg 11).

The waveform instruction signal SD1 is converted from digital to analog in the DA/AD conversion unit 194, and the converted signal is output to the power conversion instruction unit 193 as a waveform instruction signal SA1 that is an analog signal. The power conversion instruction unit 193 outputs a control signal CON to the power converting unit 111 according to the waveform instruction signal SA1.

The sensor-value readout unit 195 reads the bus voltage V₁₀₁ detected by the voltage sensor 103, and a detected value Ir of the current sensor 112 and a detected value Vr of the voltage sensor 114 in the activation target leg (the first leg 11). The sensor-value readout unit 195 outputs a readout result as a readout signal SA2 that is an analog signal. The readout signal SA2 is converted from analog to digital in the DA/AD conversion unit 194, and the converted signal is output to the operation mode management unit 192 as a readout signal SD2 that is a digital signal.

That is, the operation mode management unit 192 reads out the IP address corresponding to the first leg 11 from the leg identification information database 197 when the first leg is designated as the activation target leg. Then, the operation mode management unit 192 outputs the activation instruction to the first leg 11 using the readout IP address. Thus, the operation mode management unit 192 can activate the first leg 11 in the designated operation mode.

Next, an operation of the power router 100 will be described. In the present exemplary embodiment, an operation mode designation of each leg is included in the control instruction 52.

First, the operation mode will be described. As previously described, the first leg 11 to the fourth leg 14 include the power converting unit 111, 121, 131, and 141, and the switching operations of the thyristors in the power conversion units are controlled by the control unit 19.

Note that the power router 100 is disposed in a node of the power network system 810 and has an important role of connecting the core system 811, loads 830, distributed power supplies, power cells, and so on with each other. It should be noted that the connection terminals 115, 125, 135, and 145 of the first leg 11 to the fourth leg 14 are connected to the core system 811, loads 830, the distributed power supplies, or the power routers of other power cells. The inventors of the present application have found that the roles of the first leg 11 to the fourth leg 14 are changed according to the entities to be connected thereto and hence the power routers do not work properly unless the first leg 11 to the fourth leg 14 perform appropriate operations according to those roles. The inventors of the present application have configured the power network system so that the ways of the operations of the legs are changed according to the entities to be connected thereto, though the configurations of the legs are identical to each other.

The way of the operation of a leg is referred to as “operating mode”.

The inventors of the present application have prepared three types of operating modes for the legs and configured the power network system so that their operating modes are changed according to the entities to be connected thereto.

The operating modes for the legs include:

a master mode;

a stand-alone mode; and

a designated power transmission/reception mode.

These modes are explained hereinafter one by one.

### (Master Mode)

The master mode is an operating mode for a case where the leg is connected to a stable power supply source such as a system and for maintaining the bus voltage V₁₀₁ of the DC bus 101. FIG. 1 shows an example in which the connection terminal 115 of the first leg 11 is connected to the core system 811. In the case of FIG. 1, the first leg 11 is operated and controlled in a master mode and is in charge of maintaining the bus voltage V₁₀₁ of the DC bus 101. The other second leg 12 to the fourth leg are also connected to the DC bus 101. Power may flow into the DC bus 101 from some of the second leg 12 to the fourth leg 14 and power may flow out from some of the second leg 12 to the fourth leg 14. When power flows out from the DC bus 101 and hence the bus voltage V₁₀₁ of the DC bus 101 is lowered from its rated voltage, the first leg 11, which is in the master mode, makes up the deficiency due to the flowed-out power by using power supplied from the connected entity (the core system 811 in this example). On the other hand, when power flows into the DC bus 101 and hence the bus voltage V₁₀₁ of the DC bus 101 is raised from the rated voltage, the first leg 11 makes the excess power due to the flowed-in power flow out to the connected entity (the core system 811 in this example). In this way, the first leg 11, which is in the master mode, maintains the bus voltage V₁₀₁ of the DC bus 101.

Therefore, at least one leg has to be operated in a master mode in one power router. If not, the bus voltage V₁₀₁ of the DC bus 101 cannot be maintained at a fixed voltage. Meanwhile, two or more legs may be simultaneously operated in a master mode in one power router. However, the number of legs operating in a master mode in one power router is preferably one.

Further, the leg in a master mode may be connected to an entity other than the core system, such as a distributed power supply equipped with a self-excited inverter (including a storage battery). However, the leg in a master mode cannot be connected to a distributed power supply equipped with a separately-excited inverter.

In the following explanation, a leg operated in a master mode may be called “master leg”.

Operation control of a master leg is explained.

A master leg is activated through the following procedure.

Firstly, the switch 113 is brought into an opened (cut-off) state. The connection terminal 115 is connected to an entity to be connected in this state. In this example, the entity to be connected is the core system 811.

The voltage of the connected system is measured by the voltage sensor 114, and the amplitude, the frequency, and the phase of the voltage of the connected system are obtained by using a PLL (Phase-Locked-Loop) or the like. After that, the output of the power conversion unit 111 is adjusted so that the power conversion unit 111 outputs a voltage having amplitude, a frequency, and a phase equal to the obtained ones. That is, On/Off patterns of the thyristors 111T are determined. When this output is stabilized, the switch 113 is closed and hence the power conversion unit 111 is connected to the core system 811. At this point, since the voltage of the output of the power conversion unit 111 is synchronized with the voltage of the core system 811, no current flows therebetween.

Operation control for operating a master leg is explained. The bus voltage V₁₀₁ of the DC bus 101 is measured by the voltage sensor 103. If the bus voltage V₁₀₁ of the DC bus 101 is higher than a predetermined rated bus voltage, the power conversion unit 111 is controlled so that power is transmitted from the master leg (the first leg 11) to the system. (At least one of the amplitude and the phase of the voltage output from the power conversion unit 111 is adjusted so that power is transmitted from the DC bus 101 to the core system 811 through the master leg (the first leg 11).) Note that the rated voltage of the DC bus 101 is defined in advance by a setting.

On the other hand, if the bus voltage V₁₀₁ of the DC bus 101 is lower than the predetermined rated bus voltage, the power conversion unit 111 is controlled so that the master leg (the first leg 11) receives power from the core system 811. (At least one of the amplitude and the phase of the voltage output from the power conversion unit 111 is adjusted so that power is transmitted from the core system 811 to the DC bus 101 through the master leg (the first leg 11).) It can be understood that by performing the above-described operation of the master leg, the bus voltage V₁₀₁ of the DC bus 101 can be maintained at the predetermined rated voltage.

### (Stand-Alone Mode)

The stand-alone mode is an operating mode in which a leg generates a voltage having amplitude and/or a frequency specified by the management server 850 by itself and transmits/receives power to/from a connected entity.

For example, it is an operating mode for supplying power for an entity that consumes power such as a load 830. Alternatively, it is an operating mode for directly receiving power transmitted from a connected entity.

FIG. 1 shows an example in which the connection terminal 125 of the second leg 12 is connected to a load 830. The second leg 12 is operated and controlled in a stand-alone mode and supplies power to the load 830.

Further, when a leg is connected to another power router as in the case of the fourth 14, the fourth leg 14 may be operated in a stand-alone mode as a mode for transmitting an amount of power required from the another power router.

Alternatively, when a leg is connected to another power router as in the case of the fourth 14, the fourth leg 14 may be operated in a stand-alone mode as a mode for receiving power transmitted from the another power router.

Further, though it is not shown in the figure, when the second leg is connected to a generator facility instead of being connected to the load 830, the second leg can also be operated in a stand-alone mode. However, in this case, the generator facility needs to be equipped with a separately-excited inverter.

An operating mode that is used when power routers are connected with each other will be described later.

A leg that is operated in a stand-alone mode is referred to as “stand-alone leg”. One power router may include a plurality of stand-alone legs.

Operation control of a stand-alone leg is explained.

Firstly, the switch 123 is brought into an opened (cut-off) state. The connection terminal 125 is connected to the load 830. The management server 850 instructs the power router 100 about the amplitude and the frequency of power (voltage) that should be supplied to the load 830. Therefore, the control unit 19 performs control so that power (voltage) having the specified amplitude and the frequency is output from the power conversion unit 121 to the load 830. (That is, On/Off patterns of the thyristors 121T are determined.) When this output is stabilized, the switch 123 is closed and hence the power conversion unit 121 is connected to the load 830. After that, when power is consumed in the load 830, power equivalent to that power flows from the stand-alone leg (the second leg 12) to the load 830.

### (Designated Power Transmission/Reception Mode)

The designated power transmission/reception mode is an operating mode for exchanging a designated amount of power. That is, there are a case where a designated amount of power is transmitted to a connected entity and a case where a designated amount of power is received from a connected entity.

In FIG. 1, the fourth leg 14 is connected to other power routers.

In cases like this, a determined amount of power may be supplied from one of the power routers to the other power router.

As an alternative example, the third leg 13 is connected to a storage battery 835.

In the cases like this, a determined amount of power is transmitted to the storage battery 835 and the storage battery 835 is thereby charged.

Alternatively, a designated power transmission/reception leg may be connected to a distributed power supply equipped with a self-excited inverter (including a storage battery). However, a designated power transmission/reception leg cannot be connected to a distributed power supply equipped with a separately-excited inverter.

A leg that is operated in a designated power transmission/reception mode is referred to as “designated power transmission/reception leg”. One power router may include a plurality of designated power transmission/reception legs.

Operation control of a designated power transmission/reception leg is explained. Control that is performed when the leg is activated is fundamentally the same as that for the master leg, and therefore the explanation thereof is omitted.

Operation control for operating a designated power transmission/reception leg is explained. For the explanation, symbols assigned to the third leg 13 are used.

The voltage of the connected system is measured by the voltage sensor 134, and the frequency and/or the phase of the voltage of the connected system are obtained by using a PLL (Phase-Locked-Loop) or the like. A target value for a current input/output by the power conversion unit 131 is obtained (or calculated) based on an active power value and a reactive power value specified by the management server 850 and the frequency and the phase of the voltage of the connected entity. The present value (i.e., value at the present time) of the current is measured by the current sensor 132. The power conversion unit 131 is adjusted so that a current corresponding to a difference between the target value and the present value is additionally output. (At least one of the amplitude and the phase of the voltage output from the power conversion unit 131 is adjusted so that desired power flows between the designated power transmission/reception leg and the connected entity.)

From the above explanation, it can be understood that each of the first leg 11 to the fourth keg 14 having identical configurations can perform three different functions by changing the way of the operation control thereof.

The power router 100 can cause each leg to operate in the three operation modes described above by referring to the operation mode designation information included in the control instruction 52. Thus, the power router 100 can cause each leg to appropriately operate according to the function thereof.

First, an activation procedure of the power router 100 will be described. First, the power router causes the master leg to operate when receiving the activation instruction of the management server 850, and causes the other legs to operate after confirming that the bus voltage V₁₀₁ of the DC bus 101 is maintained constant. The power router stops an activation process when there is no leg to be the master leg or the bus voltage V₁₀₁ of the DC bus 101 is not stable due to a failure of the operation of the master leg, etc.

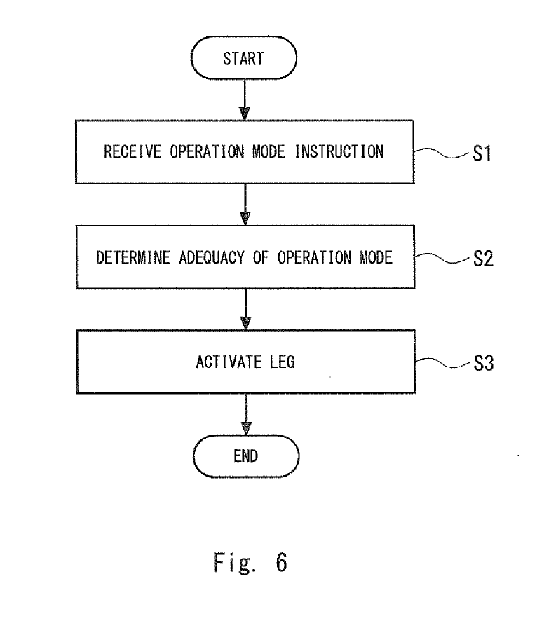

Next, a specific activation procedure of the leg described above will be described. It is necessary to activate the leg to be able to operate in the appropriate operation mode according to the operation mode designation information included in the control instruction 52 when the leg is inserted to the power router and is activated for the first time. The management server 850 designates the operation mode of the activation target leg (the first leg 11). In the present exemplary embodiment, the control unit 19 activates the leg, which is in a shutdown condition, in the designated operation mode. FIG. 6 is a flow chart showing the activation procedure of the activation target leg (the first leg 11) in the power router 100. The activation procedure of the leg in the power router consists of an operation mode instruction reception step S1, an operation mode adequacy determination S2, and a leg activation step S3.

### Operation Mode Instruction Reception Step S1

The control unit 19 receives the operation mode designation information MODE included in the control instruction 52 output from the management server 850. Specifically, the operation mode management unit 192 reads out the operation mode designation information MODE included in the control instruction database 196 in the memory unit 191.

### Operation Mode Adequacy Determination S2

The control unit 19 determines which of the master mode, the stand-alone mode, and the designated power transmission/reception mode is the operation mode of the activation target leg (the first leg 11) designated by the operation mode designation information MODE. Then, the control unit 19 determines whether the activation target leg (the first leg 11) can be activated in the designated operation mode.

### Leg Activation Step S3

The control unit 19 sets information necessary for outputting the power from the activation target leg (the first leg 11) in the designated operation mode to the activation target leg (the first leg 11). Then, the control unit 19 notifies the management server 850 whether the activation is finished.

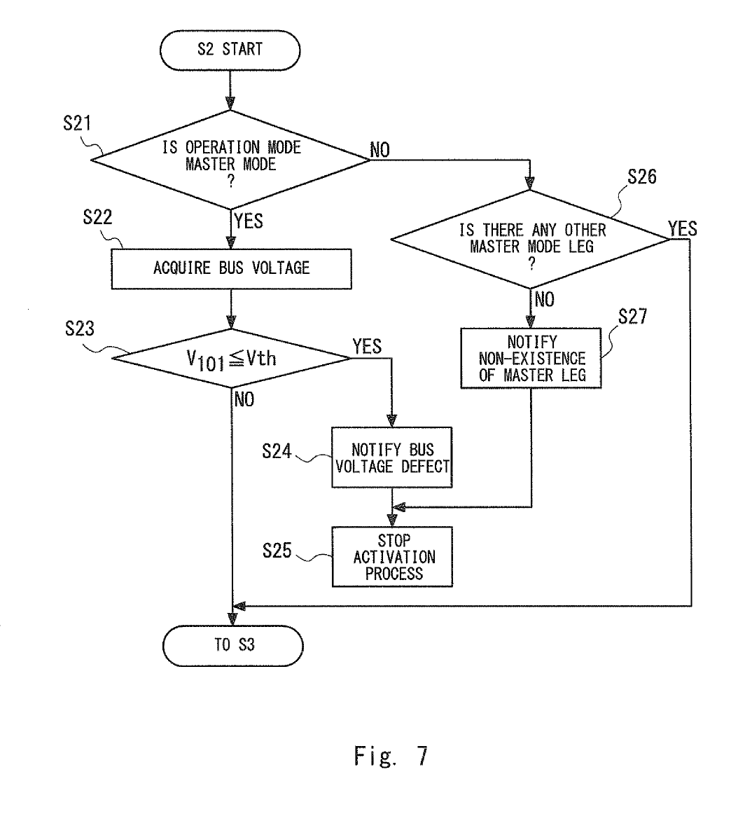

Subsequently, detail of the operation mode adequacy determination S2 will be described. FIG. 7 is a flow chart showing a procedure of the operation mode adequacy determination S2. The operation mode adequacy determination S2 includes an operation mode determination step S21, a bus voltage acquisition step S22, a bus voltage value determination step S23, a bus voltage defect notification step S24, an activation process stopping step S25, a master mode leg checking step S26, and a non-existence of the master mode leg notification step 27.

### Operation Mode Determination Step S21

The operation mode management unit 192 determines which of the master mode, the stand-alone mode, and the designated power transmission/reception mode is the operation mode of the activation target leg (the first leg 11) designated by the operation mode designation information MODE.

### Bus Voltage Acquisition Step S22

When the operation mode of the activation target leg (the first leg 11) designated by the operation mode designation information MODE is the master mode, the operation mode management unit 192 acquires the bus voltage V₁₀₁ of the DC bus 101 from the voltage 103 via the DA/AD conversion unit 194 and the sensor-value readout unit 195.

### Bus Voltage Value Determination Step S23

The operation mode management unit 192 determines whether the bus voltage V₁₀₁ acquired in the bus voltage acquisition step S22 is equal to or more than a predetermined value Vth. When the bus voltage V₁₀₁ is equal to or more than the predetermined value Vth, the flow proceeds to the leg activation step S3.

### Bus Voltage Defect Notification Step S24

When the bus voltage V₁₀₁ is less than the predetermined value Vth, the operation mode management unit 192 outputs an alarm of a bus voltage defect to the management server 850.

Activation Process Stopping Step S25 The operation mode management unit 192 stops the activation process after outputting the alarm of the bus voltage defect.

### Master Mode Leg Checking Step S26

Meanwhile, when the operation mode of the activation target leg (the first leg 11) designated by the operation mode designation information MODE is the stand-alone mode or the designated power transmission/reception mode, the operation mode management unit 192 determines whether there is a leg in which the activation in the master mode has been finished in legs other than the activation target leg (the first leg 11) in the power router 100. Specifically, the operation mode management unit 192 can refer to the control instruction database 196 in the memory unit 191 to determine whether there is the leg the operation mode of which is designated as the master mode in the power router 100. When there is the leg in which the activation in the master mode has been finished in the legs other than the activation target leg (the first leg 11) in the power router 100, the flow proceeds to the leg activation step S3.

### Non-Existence of the Master Mode Leg Notification Step 27

When there is not the leg in which the activation in the master mode has been finished in the legs other than the activation target leg (the first leg 11) in the power router 100, the operation mode management unit 192 outputs non-existence of the master mode leg to the management server 850. That is, it is possible to prevent the other operation modes from being activated in a case that there is not any master mode leg.

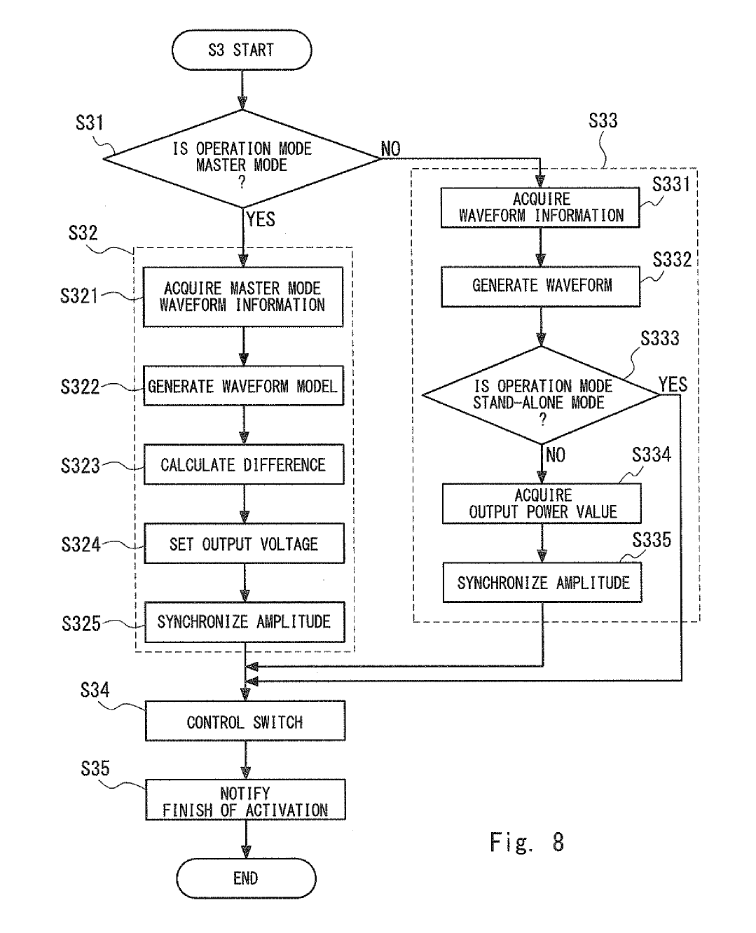

Continuously, detail of the leg activation step S3 will be described. FIG. 8 is a flow chart showing a procedure of the leg activation step S3. The leg activation step S3 includes a first operation mode determination step S31, a master mode waveform generation step S32, a non-master mode waveform generation step S33, a switch control step S34, and a finish of the activation notification step S35.

### First Operation Mode Determination Step S31

The operation mode management unit 192 determines whether the operation mode of the activation target leg (the first leg 11) designated by the operation mode designation information MODE is the master mode.

### Master Mode Waveform Generation Step S32

The master mode waveform generation step S32 is a step of generating a waveform for the power transmission in the master mode. The master mode waveform generation step S32 includes a master mode waveform-information acquisition step S321, a waveform model generation step S322, a difference calculation step S323, an output voltage determination step S324, and an amplitude synchronization step S325.

Master Mode Waveform-Information Acquisition Step S321

When the operation mode is the master mode, the operation mode management unit 192 acquires voltage amplitude and a period of the voltage waveform of a connection destination (e.g., the core system) of the activation target leg (the first leg 11). Specifically, the operation mode management unit 192 acquires a voltage Vr of the branch line BL, which is connected to outside via the terminal 115, from the voltage sensor 113 via the DA/AD conversion unit 194 and the sensor-value readout unit 195. The operation mode management unit 192 acquires the voltage amplitude and the period of the voltage waveform from the acquired voltage Vr. In this case, for example, the voltage amplitude and the period of the voltage waveform of the connection destination (e.g., the core system) can be acquired by the so-called zero-point detection.

### Waveform Model Generation Step S322

The operation mode management unit 192 generates a waveform model temporally synchronized with the acquired period. In this case, the waveform model is generated as a sinusoidal wave.

### Difference Calculation Step S323

The operation mode management unit 192 calculates a difference ΔV (ΔV=V0−V₁₀₁) between a rated value V0 of the bus voltage and the present bus voltage V₁₀₁.

### Output Voltage Determination Step S324

The operation mode management unit 192 determines an output voltage of the activation target leg (the first leg 11) according to the difference ΔV.

### Amplitude Synchronization Step S325

The operation mode management unit 192 synchronizes amplitude of the waveform model with the determined value of the output voltage. The operation mode management unit 192 outputs information of the waveform model in which a synchronization of the amplitude is finished as the waveform instruction signal SD1. The power conversion instruction unit 193 receives the waveform instruction signal SA1 that is a signal converted from the waveform instruction signal SD1 by being converted from digital to analog in the DA/AD conversion unit 194. Thus, the first leg 11 finishes a preparation for transmitting the power in synchronization with the external core system as the master leg.

### Non-Master Mode Waveform Generation Step S33

The non-master mode waveform generation step S33 is a step of generating a waveform for the power transmission in the operation mode other than the master mode. The non-master mode waveform generation step S33 includes a waveform-information acquisition step S331, a waveform model generation step S332, a second operation mode determination step S333, an output voltage value acquisition step S334, and an amplitude synchronization step S335.

### Waveform-Information Acquisition Step S331

Meanwhile, when the operation mode is the stand-alone mode or the designated power transmission/reception, the operation mode management unit 192 reads out a period of the voltage waveform of a connection destination (e.g., the leg of other power router, etc.) of the activation target leg (the first leg 11) from the control instruction database 196.

### Waveform Model Generation Step S332

The operation mode management unit 192 generates a waveform model synchronized with the readout period of the voltage waveform. In this case, the waveform model is generated as a sinusoidal wave. The operation mode management unit 192 outputs information of the generated waveform model as the waveform instruction signal SD1. The power conversion instruction unit 193 receives the waveform instruction signal SA1 that is the signal converted from the waveform instruction signal SD1 by being converted from digital to analog in the DA/AD conversion unit 194. Thus, the first leg 11 finishes a preparation for transmitting the power with the designated period.

### Second Operation Mode Determination Step S333

The operation mode management unit 192 determines whether the operation mode of the activation target leg (the first leg 11) designated by the operation mode designation information MODE is the stand-alone mode. When the operation mode is the stand-alone mode, the flow proceeds to the switch control step S34.

### Output Voltage Value Obtaining Step S334

When the operation mode is the designated power transmission/reception mode, the operation mode management unit 192 reads out an output power value in the designated power transmission/reception mode from the control instruction database 196.

### Amplitude Synchronization Step S335

The operation mode management unit 192 synchronizes amplitude of the waveform model with a value for achieving the readout output power value. The operation mode management unit 192 outputs information of the waveform model in which a synchronization of the amplitude is finished as the waveform instruction signal SD1. The power conversion instruction unit 193 receives the waveform instruction signal SA1 that is the signal converted from the waveform instruction signal SD1 by being converted from digital to analog in the DA/AD conversion unit 194. Thus, the first leg 11 finishes a preparation for transmitting the power as the designated power transmission/reception mode leg.

### Switch Control Step S34

The operation mode management unit 192 causes the switch 113 to be in a “close” condition by the switching control signal SIG1. Thus, the activation target leg (the first leg 11) can transmit the power.

### Finish of the Activation Notification Step S35

The operation mode notifies the management server 850 of that the activation of the activation target leg (the first leg 11) is finished after the master mode waveform generation step S32 or the non-master mode waveform generation step S33.

As described above, the power router 100 can activate the activation target leg, which is designated by the control instruction of the management server 850 from a plurality of the legs, in the designated operation mode. Specifically, the power router 100 receives the control instruction 52 from the management server 850 by the control unit 19. The received control instruction 52 is stored in the memory unit 191 in the control unit 19 as the control instruction database 196 and read out by the operation mode management unit 192. The operation mode management unit 192 can specifically designate the activation target leg (the first leg 11) by checking the control instruction database 196 against the leg identification information database 197. Then, the operation mode management unit 192 can activate the activation target leg (the first leg 11) in the designated operation mode. That the power router 100 receives the control instruction 52 from the management server 850 is described above. However, the power router 100 does not receive the control instruction 52 from the management server 850, and can hold the control instruction 52 in advance. Specifically, the memory unit 191 may hold the control instruction data base 101 and a control instruction schedule representing the hourly control instruction 52. The control unit 19 may also generate the control instruction 52 and send the generated control instruction 52 to the operation mode management unit 192.

According to the present configuration, it is specifically achieve a power router that can activate the activation target leg (the first leg 11), which is provided in the power router, in the designated operation mode.

Further, the power router 100 can notify the management server 850 whether the operation in the designated operation mode can be done. Thus, the management server 850 can consider whether the activation target leg can be activated, and designate the operation mode of other legs as appropriate. For example, when one activation target leg cannot be activated in the master mode, it is possible to designate another activation target leg and issue the control instruction to cause the designated activation target leg to be activated in the master mode.

### Second Exemplary Embodiment

Next, a power router 200 according to a second exemplary embodiment will be described. The power router 200 is a modification of the power router 100 according to the first exemplary embodiment. The power router 200 can further perform an initiating operation of the power transmission when the power transmission is started after the activation target leg described in the first exemplary embodiment is activated. Since a configuration and an activation operation of the activation target leg of the power router 200 are similar to those of the power router 100, descriptions of those will be omitted.

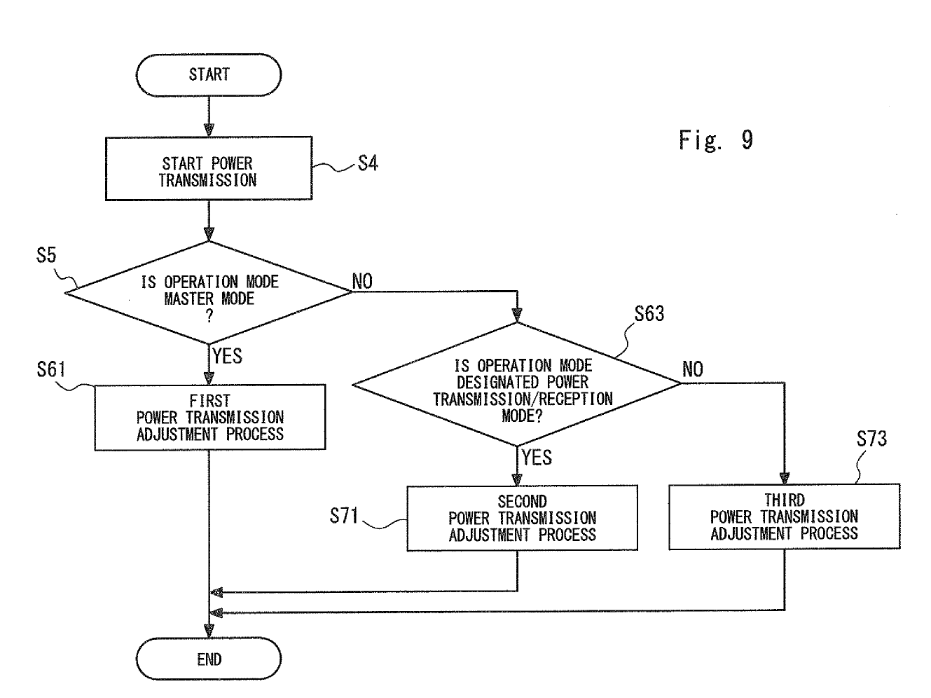

The initiating operation of the power transmission of the power router 200 will be described below. FIG. 9 is a flow chart showing a procedure of initiating the power transmission of the power router 200.

### Power Transmission Initiating Step S4

The operation mode management unit 192 outputs the waveform instruction signal SD1 instructing the start of the power transmission. The power conversion instruction unit 193 receives the waveform instruction signal SA1 that is the signal converted from the waveform instruction signal SD1 by being converted from digital to analog in the DA/AD conversion unit 194. Thus, the power converting unit 111 starts the power transmission.

### Operation Mode Determination Step S5

The operation mode management unit 192 determines whether the operation mode of the activation target leg designated by the operation mode designation information MODE is the master mode.

### First Power Transmission Adjustment Processing Step S61

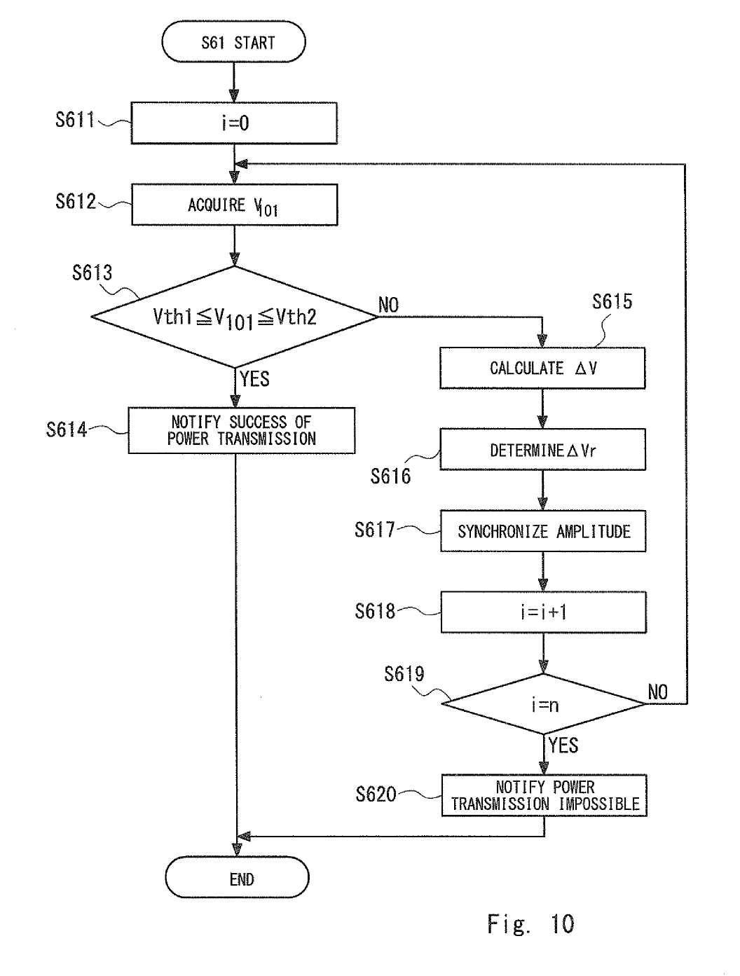

When the operation mode is the master mode, the first power transmission adjustment processing step S61 is executed. FIG. 10 is a flow chart showing a procedure of the first power transmission adjustment processing step S61. The first power transmission adjustment processing step S61 includes a number of processing initial setting step S611, a bus voltage acquisition step S612, a bus voltage determination step S613, a success of power transmission notification step S614, a differential calculation step S615, a voltage comparison step S616, an amplitude synchronization step S617, a number of voltage comparisons addition step S618, a number of comparisons checking step S619, and a power transmission impossibility notification step S620.

### Number of Processing Initial Setting Step S611

When the operation mode is the master mode, the operation mode management unit 192 sets number of voltage comparisons i to “0”.

### Bus Voltage Acquisition Step S612

The operation mode management unit 192 acquires the bus voltage V₁₀₁ of the DC bus 101 from the voltage 103 via the DA/AD conversion unit 194 and the sensor-value readout unit 195.

### Bus Voltage Determination Step S613

The operation mode management unit 192 checks whether the bus voltage V₁₀₁ falls within a predetermined range (Vth1 to Vth2)

### Success of Power Transmission Notification Step S614

When Vth1≦V₁₀₁≦Vth2, the operation mode management unit 192 notifies the management server 850 of a success of the power transmission from the activation target leg, and finishes the procedure.

### Differential Calculation Step S615

When Vth>V₁₀₁ or V₁₀₁>Vth2, the operation mode management unit 192 calculates the difference ΔV (ΔV=V0−V₁₀₁) between the range value V0 of the bus voltage and the present bus voltage V₁₀₁.

### Voltage Comparison Step S616

The operation mode management unit 192 determines the output voltage Vr of the activation target leg according to the difference AV.

### Amplitude Synchronization Step S617

The operation mode management unit 192 synchronizes the amplitude of the waveform model with the determined output voltage value. The operation mode management unit 192 outputs information of the waveform model in which a synchronization of the amplitude is finished as the waveform instruction signal SD1. The power conversion instruction unit 193 receives the waveform instruction signal SA1 that is the signal converted from the waveform instruction signal SD1 by being converted from digital to analog in the DA/AD conversion unit 194. Thus, the power conversion instruction unit 193 can change the output voltage to cause the bus voltage V₁₀₁ to approximate to the range value V0.

### Number of Voltage Comparisons Addition Step S618

The operation mode management unit 192 adds “1” to the number of voltage comparisons i.

### Number of Comparisons Checking Step S619

The operation mode management unit 192 checks whether the number of voltage comparisons i reaches a setup number n (n is an integer equal to or more than two). When in, the flow returns to the bus voltage acquisition step S612.

### Power Transmission Impossible Notification Step S620

When i=n, the operation mode management unit 192 notifies the management server 850 that the power transmission from the activation target leg is impossible.

### Operation Mode Determination Step S63

Meanwhile, when the operation mode is other than the master mode in the operation mode determination step S5, the operation mode management unit 192 determines whether the operation mode of the activation target leg designated by the operation mode designation information MODE is the designated power transmission/reception mode.

### Second Power Transmission Adjustment Processing Step S71

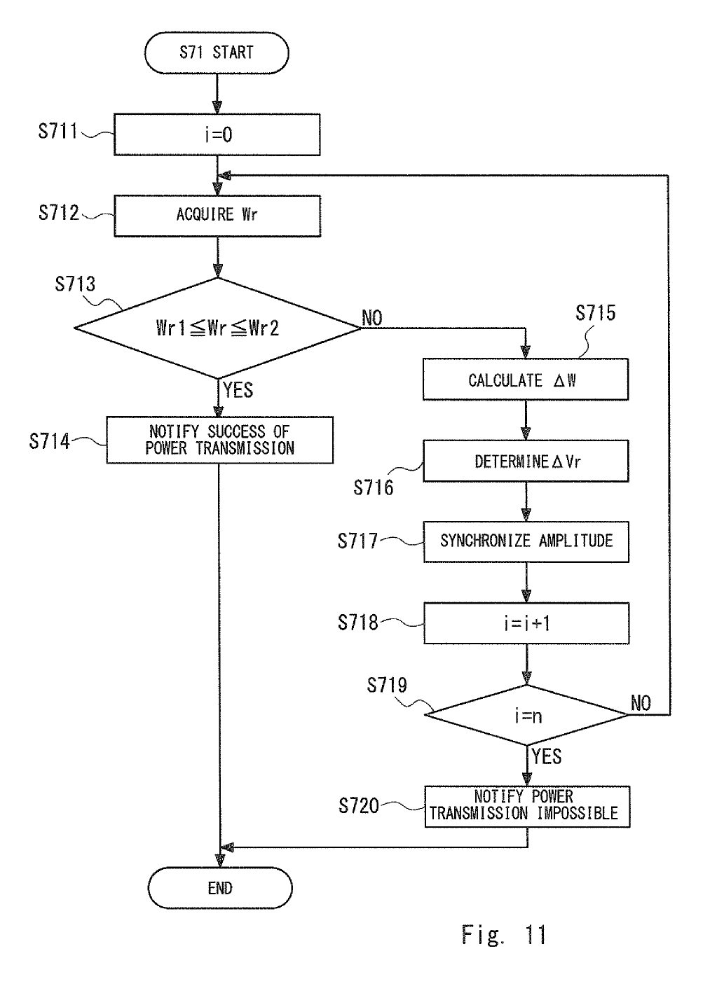

When the operation mode is the designated power transmission/reception mode, the second power transmission adjustment processing step S71 is executed. FIG. 11 is a flow chart showing a procedure of the second power transmission adjustment processing step S71. The second power transmission adjustment processing step S71 includes a number of processing initial setting step S711, an output voltage value acquisition step S712, an output voltage value determination step S713, a success of power transmission notification step S714, a difference calculation step S715, a voltage comparison step S716, an amplitude synchronization step S717, a number of the voltage comparisons addition step S718, a number of comparisons checking step S719, and a power transmission impossibility notification step S720.

### Number of Processing Initial Setting Step S711

The operation mode management unit 192 sets number of voltage comparisons i to “0”.

### Output Power Value Acquisition Step S712

The operation mode management unit 192 acquires a current value Ir of the branch line BL from the current sensor 111 and the voltage Vr of the branch line BL from the voltage sensor 114 via the DA/AD conversion unit 194 and the sensor-value readout unit 195. Thus, the operation mode management unit 192 acquires an output voltage value Wr of the activation target leg (the first leg 11).

### Output Voltage Value Determination Step S713

The operation mode management unit 192 checks whether the output voltage value Wr falls within a predetermined range (Wr1 to Wr2)

### Success of Power Transmission Notification Step S714

When Wr1≦Wr≦Wr2, the operation mode management unit 192 notifies the management server 850 of a success of the power transmission from the activation target leg, and finishes the procedure.

### Difference Calculation Step S715

When Wr1>Wr or Wr>Wr2, the operation mode management unit 192 calculates the difference ΔW (ΔW=Wr−W0) between a designated output power value W0 and the present output power value Wr.

### Voltage Comparison Step S716

The operation mode management unit 192 determines voltage amplitude of the waveform model of the activation target leg according to the difference ΔW.

### The Amplitude Synchronization Step S717

The operation mode management unit 192 synchronizes the amplitude of the waveform model with the determined output voltage value. The operation mode management unit 192 outputs information of the waveform model in which a synchronization of the amplitude is finished as the waveform instruction signal SD1. The power conversion instruction unit 193 receives the waveform instruction signal SA1 that is the signal converted from the waveform instruction signal SD1 by being converted from digital to analog in the DA/AD conversion unit 194. Thus, the power conversion instruction unit 193 can change the output voltage to cause the output power value Wr to approximate to the designated output power value W0.

### Number of Voltage Comparisons Addition Step S718

The operation mode management unit 192 adds “1” to the number of voltage comparisons i.

### Number of Comparisons Checking Step S719

The operation mode management unit 192 checks whether the number of voltage comparisons i reaches a setup number n (n is an integer equal to or more than two). When i<n, the flow returns to the output power value acquisition step S712.

### Power Transmission Impossibility Notification Step S720

When i=n, the operation mode management unit 192 stops transmitting the power and notifies the management server 850 that the power transmission from the activation target leg is impossible.

### Third Power Transmission Adjustment Processing Step S73

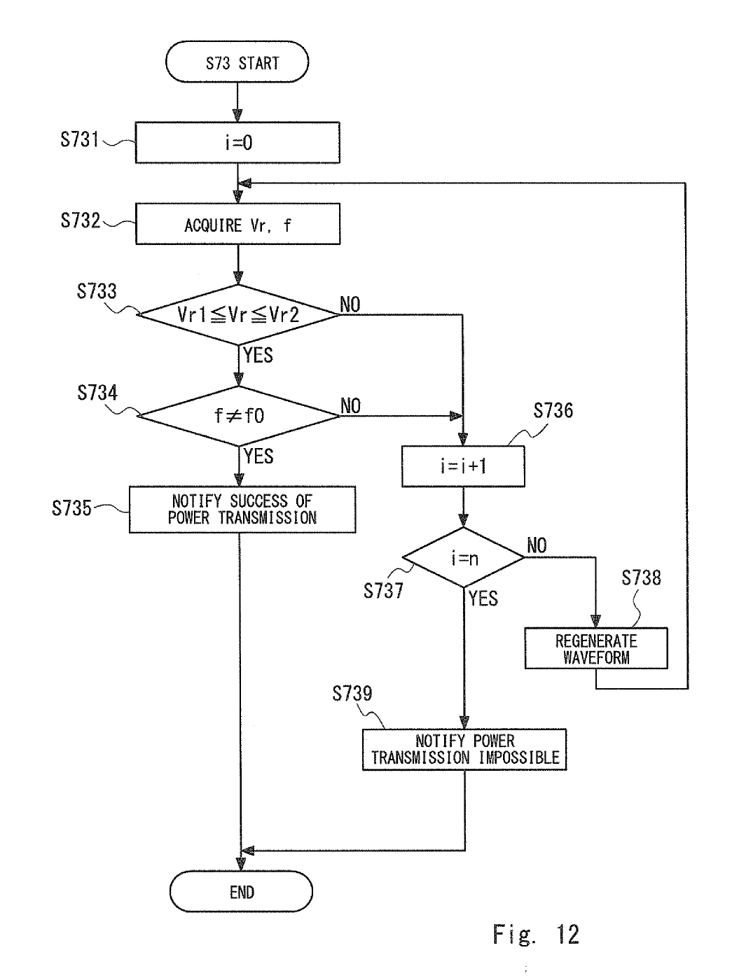

When the operation mode is not the designated power transmission/reception mode (i.e., the operation mode is the stand-alone mode), the power transmission adjustment processing step S73 is executed. FIG. 12 is a flow chart showing a procedure of the third power transmission adjustment processing step S73 of the power router 200. The third power transmission adjustment processing step S73 consists of a number of processing initial setting step S731, an output voltage/frequency acquisition step S732, an output voltage determination step S733, a frequency determination step S734, a success of power transmission notification step S735, a number of processing addition step S736, a number of processing checking step S737, a waveform model regeneration step S738, and a power transmission impossibility notification step S739.

### Number of Processing Initial Setting Step S731

The operation mode management unit 192 sets number of voltage comparisons i to “0”.

### Output Voltage/Frequency Acquisition Step S732

The operation mode management unit 192 acquires the voltage Vr of the branch line BL and a frequency of voltage variation from the voltage sensor 114 via the DA/AD conversion unit 194 and the sensor-value readout unit 195.

### Output Voltage Determination Step S733

The operation mode management unit 192 determines whether the output voltage Vr falls within a predetermined range (V1 to V2) and the frequency coincides with a setup frequency.

### Frequency Determination Step S734

When V1≦Vr≦V2, the operation mode management unit 192 determines whether the frequency f of the power transmission coincides with the setup frequency f0.

### Success of Power Transmission Notification Step S735

When Wr1≦Wr≦Wr2 and f=f0, the operation mode management unit 192 notifies the management server 850 of a success of the power transmission from the activation target leg, and finishes the procedure.

### Number of Processing Addition Step S736

The operation mode management unit 192 adds “1” to the number of voltage comparisons i.

### Number of Processing Checking Step S737

The operation mode management unit 192 checks whether the number of voltage comparisons i reaches a setup number n (n is an integer equal to or more than two).

### Waveform Model Regeneration Step S738

When V1>Vr, Vr>V2 or f=f0, the waveform model is regenerated based on a designated voltage Vs and a period. The operation mode management unit 192 outputs information of the generated waveform model as the waveform instruction signal SD1. The power conversion instruction unit 193 receives the waveform instruction signal SA1 that is the signal converted from the waveform instruction signal SD1 by being converted from digital to analog in the DA/AD conversion unit 194. Thus, the waveform model that is set to the power conversion instruction unit 193 is uploaded. After that, the flow returns to the output voltage/frequency acquisition step S732.

### Power Transmission Impossibility Notification Step S739

When i=n, the operation mode management unit 192 stops transmitting the power and notifies the management server 850 that the power transmission from the activation target leg is impossible.

As described above, the power router can not only activate the activation target leg in the designated operation mode, but also specifically achieve to start the power transmission from the leg after being activated in the designated operation mode.

Further, the power router 200 can notify the management server 850 whether the power router 200 can operate in the designated power transmission condition. Thus, the management server can consider whether the activation target leg can transmit the power and designate the other operation mode of other legs as appropriate. For example, when one activation target leg cannot transmit the power in the master mode, it is possible to designate another activation target leg and issue the control instruction to cause the designated activation target leg, to be activated in the master mode.

### Third Exemplary Embodiment

Next, a third exemplary embodiment will be described. In the present exemplary embodiment, an example of a power network system configured by using one or more power routers will be described. Note that the power network system is configured by using power routers 1011 to 1014, and any power routers according to the first and second exemplary embodiments may be used as each of the power routers 1011 to 1014.

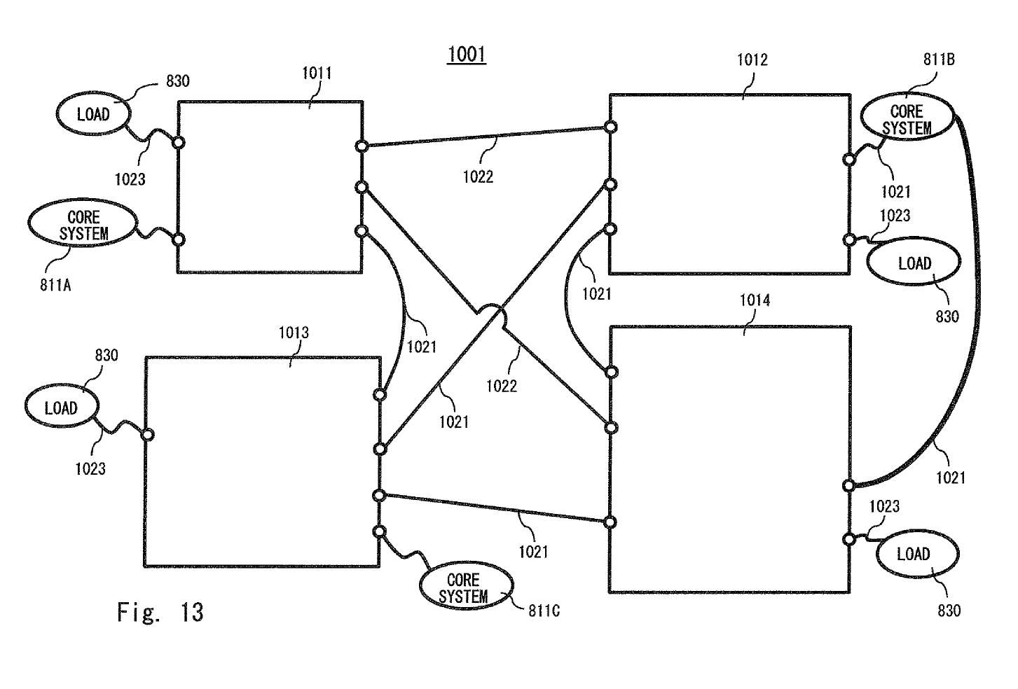

FIG. 13 is a block diagram schematically showing a configuration of a power network system 1001 that is an example of a power network system. In FIG. 13, for simplifying the drawing, numerical signs of the legs are omitted. White circle attached to the power routers 1011 to 1014 represent connection terminals, respectively.

Here, a connection line connecting the power router with connection destination will be complemented. When a connection line connecting the power routers with each other is referred to as a power transmission line, the power transmission line may be a part of the core system or separated from the core system. In FIG. 13, a numerical sign 1021 is attached to the power transmission line that is a part of the core system, and a numerical sign 1022 is attached to the power transmission line that is separated from the core system. That is, a plurality of the power routers are connected with the core system. A power can be interchanged among a plurality of the power routers via the core system by connecting the tow or more power routers via the core system in such manner, so that it is also possible to compensate deficiency and excess of the interchanged power by the core system. Meanwhile, two or more power routers can be connected with each other without interposition of the core system.

Further, when a connection line connecting the power router with the load 830 (or a distributed power source) is referred to as a power distribution line 1023, the power distribution line 1023 is separated from the core systems 811A to 811C. That is, the power distribution line 1023 that connects the power router with the load 830 (or a distributed power source) is not connected with the core systems 811A to 811C.

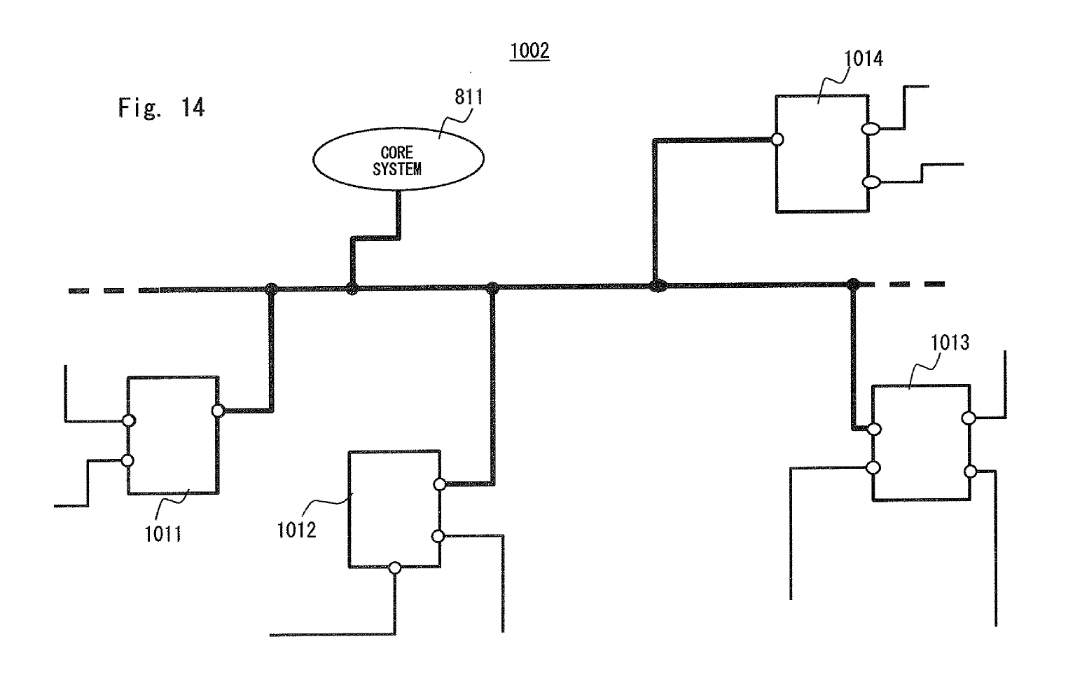

Another example of the power network system will be described. FIG. 14 is a block diagram schematically showing a configuration of a power network system 1002 that is an example of a power network system. In FIG. 14, for simplifying the drawing, only the power routers 1011 to 1014 and the core system 811 are represented. In FIG. 14, the connection line is represented by a thick line, and the power distribution line is represented by a thin line. As shown in FIG. 18, the power routers 1011 to 1014 may be connected in a manner of a bus connection.

Although a description of the operation mode of each leg will be omitted, it will be appreciated that the operation mode of each leg has to be selected by appropriately in consideration of a direction of the power interchange and the connection restriction described above.

Note that it will be appreciated that the core system 811 may be replaced with the distributed power source such as a storage battery and a generator facility. That is, a plurality of the power routers may be connected with the distributed power source in a manner of the bus connection.

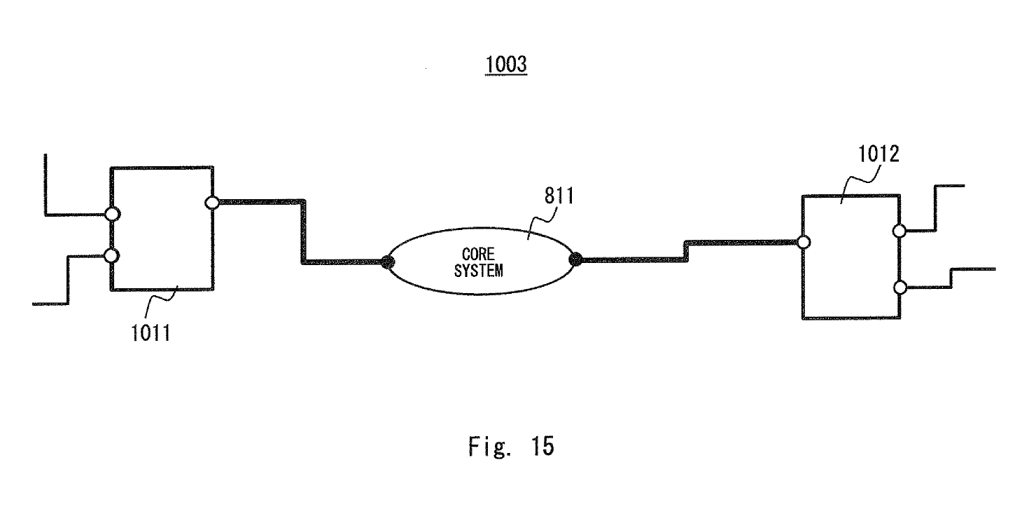

Further, another example of the power network system will be described. FIG. 15 is a block diagram schematically showing a configuration of a power network system 1003 that is an example of a power network system. In FIG. 15, for simplifying the drawing, only the power routers 1011 and 1012 and the core system 811 are represented. In FIG. 19, the connection line is represented by a thick line, and the power distribution line is represented by a thin line. As shown in FIG. 15, a configuration in which the power routers 1011 and 1012 are connected with the core system 811 may be adopted. Note that it will be appreciated that the core system 811 may be replaced with the distributed power source.

As described above, the core system, the distributed power source including the storage battery and the power facility, and the power routers is regarded as the connection destination of the power router. In the present specification and claims, these are referred to as a power system.

As described above, according to the power router of the present exemplary embodiment, the effects described below can be provided.

That is, the power network system in which the power cells are asynchronously connected with each other can be configured. Then, as described in the present exemplary embodiment, it is possible to cause the leg in the power router to operate just as the control instruction from the management server and specifically manage the power interchange or the like in the power network system.

### Other Exemplary Embodiments

Further, the present invention is not limited to the above-described exemplary embodiments, and needless to say, various modifications can be made without departing from the spirit and scope of the present invention described above. For example, although the control unit 19 is described as a hardware configuration in the above-described exemplary embodiments, it is not limited to the hardware configurations. The control unit 19 may be configured by a computer and arbitrary processing can be also implemented by causing a CPU (Central Processing Unit) to execute a computer program. The power converting unit incorporates a control device therein, and the control devise is, for example, a dynamic reconfiguration logic (FPGA:Field Programmable Gate Array). A content of the control program of the FPGA is changed to suit the mode of the legs, and then the control program operates. Thus, scale of the hardware and a cost can be decreased, because an operation can be controlled according to the operation mode by rewriting the FPGA according to a type of the leg and the operation. The above-described program can be stored in various types of non-transitory computer readable media and thereby supplied to computers. The non-transitory computer readable media includes various types of tangible storage media. Examples of the non-transitory computer readable media include a magnetic recording medium (such as a flexible disk, a magnetic tape, and a hard disk drive), a magneto-optic recording medium (such as a magneto-optic disk), a CD-ROM (Read Only Memory), a CD-R, and a CD-R/W, a DVD (Digital Versatile Disc), a BD (Blu-ray (registered trademark) Disc), and a semiconductor memory (such as a mask ROM, a PROM (Programmable ROM), an EPROM (Erasable PROM), a flash ROM, and a RAM (Random Access Memory)). Further, the program can be supplied to computers by using various types of transitory computer readable media. Examples of the transitory computer readable media include an electrical signal, an optical signal, and an electromagnetic wave. The transitory computer readable media can be used to supply programs to computer through a wire communication path such as an electrical wire and an optical fiber, or wireless communication path.

Although the present invention is explained above with reference to exemplary embodiments, the present invention is not limited to the above-described exemplary embodiments. Various modifications that can be understood by those skilled in the art can be made to the configuration and details of the present invention within the scope of the invention.

This application is based upon and claims the benefit of priority from Japanese patent applications No. 2013-013633, filed on Jan. 28, 2013, the disclosure of which is incorporated herein in its entirety by reference.

### REFERENCE SIGNS LIST

11, 21, 31, 41 FIRST LEGS
12, 22, 32, 42 SECOND LEGS
13, 23, 33, 43 THIRD LEGS
14, 24, 34, 44 FORTH LEGS
19 CONTROL UNIT
52 CONTROL INSTRUCTION
60 AC THROUGH LEG
100, 170, 200, 1011 TO 1014 POWER ROUTERS
101 DIRECT CURRENT (DC) BUS
102 COMMUNICATION BUS
103 VOLTAGE SENSOR
111, 121, 131, 141, 151 POWER CONVERTING UNITS
111D FEEDBACK DIODE
111P ANTIPARALLEL CIRCUIT
111T THYRISTOR
112, 122, 132, 142, 152, 162 CURRENT SENSORS
113, 123, 133, 143, 153, 163 SWITCHES
114, 124, 134, 144, 154, 164 VOLTAGE SENSORS
115, 125, 135, 145, 155, 165 CONNECTION TERMINALS
121T THYRISTOR
191 MEMORY UNIT
192 OPERATION MODE MANAGEMENT UNIT
193 POWER CONVERSION INSTRUCTION UNIT
194 DA/AD CONVERSION UNIT
195 SENSOR-VALUE READOUT UNIT
196 CONTROL INSTRUCTION DATABASE (#1DB)
197 LEG IDENTIFICATION INFORMATION DATABASE (#2DB)
810, 1001 TO 1003 POWER NETWORK SYSTEMS
811, 811A TO 811C CORE SYSTEMS
812 LARGE-SCALE POWER PLANT
821 TO 824 POWER CELLS
831 HOUSES
832 BUILDINGS
833 SOLAR PANEL
834 AEROGENERATOR
835 STORAGE BATTERY
841 TO 844 POWER ROUTERS
850 MANAGEMENT SERVER
851 COMMUNICATION NETWORK
1021, 1022 CONNECTION LINE
1023 POWER DISTRIBUTION LINE
BL BRANCH LINE
MODE OPERATION MODE DESIGNATION INFORMATION
SA1, SD1 WAVEFORM INSTRUCTION SIGNALS
SA2, SD2 READOUT SIGNALS
SCON CONTROL SIGNAL
SIG1 SWITCHING CONTROL SIGNAL

1. A power router comprising:
a direct current bus the voltage of which is controlled to be maintained at a first voltage level;
a plurality of power conversion legs that bi-directionally converts power between a first connection terminal and a second connection terminal, the first connection terminal of the power conversion leg being connected with the direct current bus, the second connection terminal of the power conversion leg being connected with an external connection destination as an external connection terminal; and
a control unit that controls operations of the plurality of power conversion legs; wherein
the control unit:
receives a control instruction including a designation of an activation target leg that is a target leg to be activated in the plurality of power conversion legs and a designation of an operation mode of the activation target leg;
determines whether the activation target leg can be activated in a designated operation mode; and
activates the activation target leg in the designated operation mode when the activation target leg can be activated in the designated operation mode.

2. The power router according to claim 1, wherein
when determining, the control unit:
determines which of a master mode, a designated power transmission/reception mode, and a stand-alone mode is the operation mode designated by the control instruction is the operation mode designated by the control instruction, and
determines whether the activation target leg can be activated in each operation mode,
in the master mode, the power conversion leg transmits power to or receives power from the connection partner to maintain the direct current bus voltage at the voltage level,
in the a designated power transmission/reception mode, the power conversion leg transmits power to the connection partner or receives power from the connection partner, and
in the stand-alone mode, the power conversion leg produces a voltage and a frequency and transmits power at the produced voltage and frequency to the second Power conversion leg.

3. The power router according to claim 2, wherein
the control unit:
acquires the voltage of the direct current bus when the operation mode designated by the control instruction is the master mode;
determines that the activation target leg can be activated when the voltage of the direct current bus is larger than a second voltage level; and
notifies outside of a bus voltage defect and stops activating the activation target leg when the voltage of the direct current bus is smaller than the second voltage level.

4. The power router according to claim 2, wherein
when the operation mode designated by the control instruction is not the master mode, the control unit:
determines whether there is a leg operating in the master mode in the plurality of power conversion legs other than the activation target leg;
determines that the activation target leg can be activated when there is the leg operating in the master mode; and
notifies outside that there is not the leg of the master mode and stops activating the activation target leg when there is not the leg operating in the master mode.

5. The power router according to claim 1, wherein
the power conversion leg comprises:
a power conversion unit that is connected between the first connection terminal and the second connection terminal and bi-directionally converts the power between the first connection terminal and the second connection terminal;
a current sensor that detects a current flowing between the power conversion unit and the second connection terminal;
a switch that is inserted between the power conversion unit and the second connection terminal and connects or disconnects between the power conversion unit and the second connection terminal; and
a voltage sensor that detects a voltage between the switch and the second connection terminal.

6. The power router according to claim 5, wherein
when the activation target leg can be activated, the control unit:
determines which of the master mode, the designated power transmission/reception mode, and the stand-alone mode is the operation mode designated by the control instruction; and
activates the activation target leg in a different condition in each operation mode.

7. The power router according to claim 6, wherein
when the operation mode designated by the control instruction is the master mode, the control unit:
acquires voltage amplitude and a frequency of a connection destination from the voltage sensor in the activation target leg;
generates a waveform model that is temporally synchronized with the frequency;
calculates a difference between the voltage of the direct current bus and the voltage amplitude; and
sets amplitude of the waveform model based on the difference and sets the waveform model to the power conversion unit in the activation target leg.

8. The power router according to claim 7, wherein
when the operation mode designated by the control instruction is not the master mode, the control unit:
acquires a frequency of a waveform model included in the control instruction; and
generates a waveform model that is temporally synchronized with the frequency.

9. The power router according to claim 7, wherein
the control unit:
determines which of the designated power transmission/reception mode and the stand-alone mode is the operation mode designated by the control instruction;
when the operation mode designated by the control instruction is the designated power transmission/reception mode,
acquires amplitude of a waveform model included in the control instruction; and
sets the acquired amplitude as the amplitude of the waveform model and sets the waveform model to the power conversion unit in the activation target leg; and
when the operation mode designated by the control instruction is the stand-alone mode, sets the generated waveform model to the power conversion unit in the activation target leg.

10. The power router according to claim 8, wherein
after setting the waveform model of the power conversion unit, the control unit:
controls the switch to connect the power conversion unit with the second connection terminal; and
notifies outside that the activation is finished.

11. The power router according to claim 7, wherein the control unit causes the activation target leg to start a power transmission to a connection destination after the activation of the activation target leg is finished.

12. The power router according to claim 11, wherein the control unit adjusts a condition of the power transmission according to the operation mode designated by the control instruction.

13. The power router according to claim 12, wherein
when the operation mode designated by the control instruction is the master mode, the control unit:
acquires the voltage of the direct current bus;
determines whether the voltage of the direct current bus falls within a predetermined range; and
notifies outside of a success of the power transmission when the voltage of the direct current bus falls within the predetermined range.

14. The power router according to claim 13, wherein
when the voltage of the direct current bus does not fall within the predetermined range, the control unit:
calculates a difference between a rated value of the voltage of the direct current bus and the voltage of the direct current bus;
determines an output voltage of the activation target leg based on the calculated difference;
sets the determined output voltage as the amplitude of the waveform model and sets the waveform model to the power conversion unit in the activation target leg;
acquires the voltage of the direct current bus again; and
determines whether the voltage of the direct current bus falls within the predetermined range.

15. The power router according to claim 14, wherein the control unit stops the power transmission from the activation target leg and notifies outside that the power transmission is impossible when number of determinations of whether the voltage of the direct current bus falls within the predetermined range is a predetermined number.

16. The power router according to claim 12, wherein
when the operation mode designated by the control instruction is the designated power transmission/reception mode, the control unit:
acquires an output voltage of the activation target leg;
determines whether the output voltage falls within a predetermined range; and
notifies outside of a success of the power transmission when the output voltage falls within the predetermined range.

17. The power router according to claim 16, wherein
when the output voltage does not fall within the predetermined range, the control unit:
calculates a difference between a rated value of the output voltage and the output voltage;
determines the output voltage of the activation target leg based on the calculated difference;
sets the determined output voltage as the amplitude of the waveform model and sets the waveform model to the power conversion unit in the activation target leg;
acquires the output voltage again; and
determines whether the output voltage falls within the predetermined range.

18. The power router according to claim 17, wherein the control unit stops the power transmission from the activation target leg and notifies outside that the power transmission is impossible when number of determinations of whether the output voltage falls within the predetermined range is a predetermined number.

19. The power router according to claim 12, wherein,
when the operation mode designated by the control instruction is the stand-alone mode, the control unit:
acquires an output voltage and a frequency designated by the control instruction;
determines whether the output voltage falls within a predetermined range;
determines whether the frequency is a predetermined value; and
notifies outside of a success of the power transmission when the output voltage falls within the predetermined range and the frequency is the predetermined value.

20. The power router according to claim 19, wherein
when the output voltage does not fall within the predetermined range or the frequency is not the predetermined value, the control unit:
acquires an output voltage and a frequency designated by the control instruction;
regenerates the waveform model based on the acquired output voltage and frequency, and sets the regenerated waveform model to the power conversion unit in the activation target leg;
acquires the output voltage and the frequency again;
determines whether the output voltage falls within the predetermined range; and
determines whether the frequency is the predetermined value.

21. The power router according to claim 19, wherein
when number of determinations of whether the output voltage falls within the predetermined range and the frequency is the predetermined value is a predetermined number, the control unit causes the activation target leg to stop the power transmission and notifies outside that the power transmission is impossible.

22. A power network system comprising:
one or more power routers; and
a power system that is directly or indirectly connected with the power router, wherein
each of the one or more power routers comprises:
a direct current bus the voltage of which is controlled to be maintained at a voltage level;
a plurality of power conversion legs that bi-directionally converts power between a first connection terminal and a second connection terminal, the first connection terminal of the power conversion leg being connected with the direct current bus, the second connection terminal of the power conversion leg being connected with an external connection destination as an external connection terminal; and
a control unit that controls operations of the plurality of power conversion legs, and
the control unit:
receives a control instruction including a designation of an activation target leg that is a target leg to be activated in the plurality of power conversion legs and a designation of an operation mode of the activation target leg;
determines whether the activation target leg can be activated in a designated operation mode; and
activates the activation target leg in the designated operation mode when the activation target leg can be activated in the designated operation mode.

23. An operation control method of a power router, the power router including:
a direct current bus the voltage of which is controlled to be maintained at a voltage level;
a plurality of power conversion legs that bi-directionally converts power between a first connection terminal and a second connection terminal, the first connection terminal of the power conversion leg being connected with the direct current bus, the second connection terminal of the power conversion leg being connected with an external connection destination as an external connection terminal; and
a control unit that controls operations of the plurality of power conversion legs,
the method comprising:
receiving a control instruction including a designation of an activation target leg that is a target leg to be activated in the plurality of power conversion legs and a designation of an operation mode of the activation target leg;
determining whether the activation target leg can be activated in a designated operation mode; and
activating the activation target leg in the designated operation mode when the activation target leg can be activated in the designated operation mode.

24. A non-transitory computer readable media storing a power router operation control program, the power router including:
a direct current bus the voltage of which is controlled to be maintained at a voltage level;
a plurality of power conversion legs that bi-directionally converts power between a first connection terminal and a second connection terminal, the first connection terminal of the power conversion leg being connected with the direct current bus, the second connection terminal of the power conversion leg being connected with an external connection destination as an external connection terminal; and
a computer that configures a control unit controlling operations of the plurality of power conversion legs, and
the program causing the computer to execute:
a process of receiving a control instruction including a designation of an activation target leg that is a target leg to be activated in the plurality of power conversion legs and a designation of an operation mode of the activation target leg;
a process of determining whether the activation target leg can be activated in a designated operation mode; and
a process of activating the activation target leg in the designated operation mode when the activation target leg can be activated in the designated operation mode.

25. A non-transitory computer readable media storing a management device control program comprising:
one or more power routers;
a power system that is directly or indirectly connected with the power router; and
a computer that configures a management device controlling operations of the one or more power routers, wherein
each of the one or more power routers comprises:
a direct current bus the voltage of which is controlled to be maintained at a voltage level;
a plurality of power conversion legs that bi-directionally converts power between a first connection terminal and a second connection terminal, the first connection terminal of the power conversion leg being connected with the direct current bus, the second connection terminal of the power conversion leg being connected with an external connection destination as an external connection terminal; and
a control unit that controls operations of the plurality of power conversion legs,
the program causes the computer to execute a process of outputting a control instruction including a designation of an activation target leg that is a target leg to be activated in the plurality of power conversion legs and a designation of an operation mode of the activation target leg to the activation target leg included in any one of the one or more power routers, and
the control unit:
determines whether the activation target leg can be activated in a designated operation mode; and
activates the activation target leg in the designated operation mode when the activation target leg can be activated in the designated operation mode.

26. A power router comprising:
a direct current bus the voltage of which is controlled to be maintained at a voltage level;
a plurality of power conversion legs that bi-directionally converts power between a first connection terminal and a second connection terminal, the first connection terminal of the power conversion leg being connected with the direct current bus, the second connection terminal of the power conversion leg being connected with an external connection destination as an external connection terminal; and
a control means for controlling controls operations of the plurality of power conversion legs; wherein
the control means:
receives a control instruction including a designation of an activation target leg that is a target leg to be activated in the plurality of power conversion legs and a designation of an operation mode of the activation target leg;
determines whether the activation target leg can be activated in a designated operation mode; and
activates the activation target leg in the designated operation mode when the activation target leg can be activated in the designated operation mode.

27. A power network system comprising:
one or more power routers; and
a power system that is directly or indirectly connected with the power router, wherein
each of the one or more power routers comprises:
a direct current bus the voltage of which is controlled to be maintained at a voltage level;
a plurality of power conversion legs that bi-directionally converts power between a first connection terminal and a second connection terminal, the first connection terminal of the power conversion leg being connected with the direct current bus, the second connection terminal of the power conversion leg being connected with an external connection destination as an external connection terminal; and
a control means for controlling operations of the plurality of power conversion legs, and
the control means:
receives a control instruction including a designation of an activation target leg that is a target leg to be activated in the plurality of power conversion legs and a designation of an operation mode of the activation target leg;
determines whether the activation target leg can be activated in a designated operation mode; and
activates the activation target leg in the designated operation mode when the activation target leg can be activated in the designated operation mode.

28. An operation control method of a power router, the power router including:
a direct current bus the voltage of which is controlled to be maintained at a voltage level;
a plurality of power conversion legs that bi-directionally converts power between a first connection terminal and a second connection terminal, the first connection terminal of the power conversion leg being connected with the direct current bus, the second connection terminal of the power conversion leg being connected with an external connection destination as an external connection terminal; and
a control means for controlling operations of the plurality of power conversion legs,
the method comprising:
receiving a control instruction including a designation of an activation target leg that is a target leg to be activated in the plurality of power conversion legs and a designation of an operation mode of the activation target leg;
determining whether the activation target leg can be activated in a designated operation mode; and
activating the activation target leg in the designated operation mode when the activation target leg can be activated in the designated operation mode.

29. A non-transitory computer readable media storing a power router operation control program, the power router including:
a direct current bus the voltage of which is controlled to be maintained at a voltage level;
a plurality of power conversion legs that bi-directionally converts power between a first connection terminal and a second connection terminal, the first connection terminal of the power conversion leg being connected with the direct current bus, the second connection terminal of the power conversion leg being connected with an external connection destination as an external connection terminal; and
a computer that configures a control means for controlling operations of the plurality of power conversion legs, and
the program causing the computer to execute:
a process of receiving a control instruction including a designation of an activation target leg that is a target leg to be activated in the plurality of power conversion legs and a designation of an operation mode of the activation target leg;
a process of determining whether the activation target leg can be activated in a designated operation mode; and
a process of activating the activation target leg in the designated operation mode when the activation target leg can be activated in the designated operation mode.

30. A non-transitory computer readable media storing a management device control program comprising:
one or more power routers;
a power system that is directly or indirectly connected with the power router; and
a computer that configures a management device controlling operations of the one or more power routers, wherein
each of the one or more power routers comprises:
a direct current bus the voltage of which is controlled to be maintained at a voltage level;
a plurality of power conversion legs that bi-directionally converts power between a first connection terminal and a second connection terminal, the first connection terminal of the power conversion leg being connected with the direct current bus, the second connection terminal of the power conversion leg being connected with an external connection destination as an external connection terminal; and
a control means for controlling operations of the plurality of power conversion legs,
the program causes the computer to execute a process of outputting a control instruction including a designation of an activation target leg that is a target leg to be activated in the plurality of power conversion legs and a designation of an operation mode of the activation target leg to the activation target leg included in any one of the one or more power routers, and
the control means:
determines whether the activation target leg can be activated in a designated operation mode; and
activates the activation target leg in the designated operation mode when the activation target leg can be activated in the designated operation mode.
